(19) United States
(12) Patent Application Publication
(10) Pub. No.: US 2024/0428140 A1
(43) Pub. Date: Dec. 26, 2024

(54) INFORMATION PROCESSING DEVICE AND INFORMATION PROCESSING METHOD

(71) Applicant: Mitsubishi Electric Corporation, Tokyo (JP)

(72) Inventors: Yusuke YAMAKAJI, Tokyo (JP); Kunihiko FUKUSHIMA, Tokyo (JP)

(73) Assignee: Mitsubishi Electric Corporation, Tokyo (JP)

(21) Appl. No.: 18/822,999

(22) Filed: Sep. 3, 2024

Related U.S. Application Data
(63) Continuation of application No. PCT/JP2022/014203, filed on Mar. 25, 2022.

(51) Int. Cl. G06N 20/00

(52) U.S. Cl. CPC G06N 20/00

(57) ABSTRACT

An information processing device includes: a first feature value extracting unit extracting a feature value of input data; a first probability calculating unit performing inference on the input data based on the feature value, and calculates a probability to classify the input data into each of a first number of classes; and a first classification unit classifying the input data into at least one of the first number of classes based on the probability. The first classification unit rearranges the input data so that the probability is in ascending or descending order, extracts a label having a maximum probability from the rearranged input data, compares the label having the maximum probability with a correct answer label, stores a class in which the labels coincide with each other, stores a class in which the labels do not coincide with each other, and statistically processes the stored classes.

### CROSS REFERENCE TO RELATED APPLICATION

This application is a Continuation of PCT International Application No. PCT/JP2022/014203, filed on Mar. 25, 2022, which is hereby expressly incorporated by reference into the present application.

### TECHNICAL FIELD

The present disclosure relates to an information processing device and an information processing method.

### BACKGROUND ART

In general, a neural network used for classification of input data such as image recognition outputs an inference result on the basis of a probability for each classification result when classifying the input data (see Patent Literature 1).

### CITATION LIST

### Patent Literature

Patent Literature 1: JP 2013-117861 A

### SUMMARY OF INVENTION

### Technical Problem

By the way, in general, when an inference is performed on the basis of a probability for each classification result, it is difficult to determine a probability as a reference, and it is necessary to determine an appropriate probability by an empirical rule or trial and error. Therefore, it is necessary to perform machine learning of a neural network or the like to be used and to perform redesign each time input data changes.

The present disclosure has solved the above problems, and an object of the present disclosure is to provide an information processing device and an information processing method capable of determining an appropriate probability depending on machine learning to be used and input data to be used on the basis of an inference result of the machine learning.

### Solution to Problem

An information processing device according to the present disclosure includes: a processor; and a memory storing a program, upon executed by the processor, performing a process: to extract a feature value of input data; to perform inference on the input data on a basis of the feature value extracted, and to calculate a probability with which the input data is classified into each of a first number of classes; and to classify the input data into at least one of the first number of classes on a basis of the probability calculated, wherein the process performs a first process of rearranging the input data in such a manner that the probability calculated is in ascending or descending order, a second process of extracting a label having a maximum probability from the rearranged input data, a third process of comparing the label having the maximum probability with a correct answer label associated with the input data, a first storage process of storing a class obtained in the first process, in which the labels coincide with each other as a comparison result of the third process, a second storage process of storing a class obtained in the first process, in which the labels do not coincide with each other as a comparison result of the third process, a first statistical process of statistically processing the class stored by the first storage process, a second statistical process of statistically processing the class stored by the second storage process, and to classify the input data on a basis of the comparison result between the probability calculated and the threshold value set on a basis of at least one of the results of the first statistical process and the second statistical process.

### Advantageous Effects of Invention

According to the present disclosure, with the above-described configuration, an appropriate probability can be determined on the basis of an inference result of machine learning depending on machine learning to be used and input data to be used.

### BRIEF DESCRIPTION OF DRAWINGS

FIG. 1 is a configuration diagram illustrating an example of a hardware configuration of an information processing device according to a first embodiment.

FIG. 2 is a block diagram illustrating a configuration of the information processing device according to the first embodiment.

FIG. 3 is a flowchart illustrating processing performed by the information processing device according to the first embodiment.

FIG. 4 is a flowchart illustrating processing of setting a threshold, performed by the information processing device according to the first embodiment.

FIG. 5 is a flowchart illustrating a modification of the processing performed by the information processing device according to the first embodiment.

FIG. 6 is a diagram illustrating an example of a dataset of an image input to the information processing device according to the first embodiment.

FIG. 7 is a diagram illustrating an example of a dataset of a graph input to the information processing device according to the first embodiment.

FIG. 8 is a diagram illustrating an example of a dataset of a natural language input to the information processing device according to the first embodiment.

FIG. 9 is a diagram illustrating an example of a dataset of a time waveform of a signal input to the information processing device according to the first embodiment.

FIG. 10 is a flowchart illustrating an example of a neural network for multi-value classification and 2-value classification of the information processing device according to the first embodiment.

FIG. 11 is a diagram illustrating an example of a second dataset generated by the information processing device according to the first embodiment.

FIG. 12 is a diagram illustrating the number of pieces of data for which 2-value classification has been calculated for a threshold by the information processing device according to the first embodiment among 10,000 pieces of test data of CIFAR10.

FIG. 13 is a diagram illustrating experimental data of an inference result in a case where the information processing device according to the first embodiment uses 2-value classification for CIFAR10 and a case where the information processing device does not use 2-value classification for CIFAR10.

FIG. 14 is a diagram illustrating experimental data of time required for the information processing device according to the first embodiment to infer 10,000 pieces of data for a threshold of CIFAR10.

FIG. 15 is a diagram illustrating an example of a second dataset generated by an information processing device according to a third embodiment.

FIG. 16 is a table presenting inference accuracy by a second training unit of the information processing device according to the third embodiment.

FIG. 17 is a graph illustrating an average value of inference accuracy by the information processing device according to the first and fifth embodiments.

FIG. 18 is a graph illustrating a median value of inference accuracy by the information processing device according to the first and fifth embodiments.

### DESCRIPTION OF EMBODIMENTS

Hereinafter, embodiments according to the present disclosure will be described in detail with reference to the drawings.

### First Embodiment

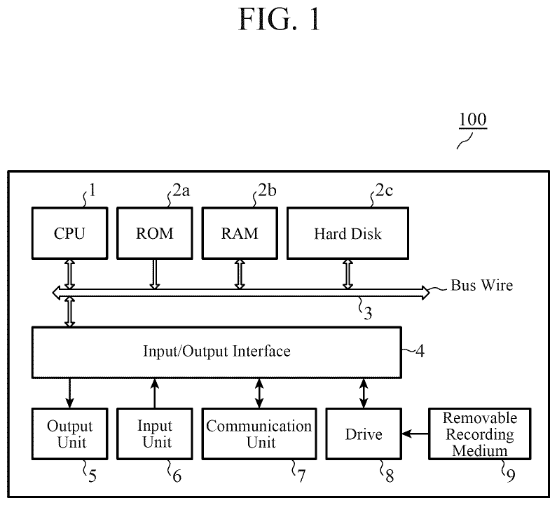

A hardware configuration of an information processing device 100 according to a first embodiment will be described with reference to FIG. 1. FIG. 1 is a configuration diagram illustrating an example of the hardware configuration of the information processing device 100 according to the first embodiment. The information processing device 100 may be a stand-alone computer not connected to an information network, or may be a server or a client of a server client system connected to a cloud or the like via an information network. In addition, the information processing device 100 may be a smartphone or a microcomputer. In addition, the information processing device 100 may be a computer used in a network environment closed in a factory, which is called edge computing.

For example, the information processing device 100 includes a central processing unit (CPU) 1, a read only memory (ROM) 2a, a random access memory (RAM) 2b, a hard disk (HDD) 2c, and an input/output interface 4, which are connected to each other via a bus wire 3. In addition, for example, the information processing device 100 includes an output unit 5, an input unit 6, a communication unit 7, and a drive 8 connected to the input/output interface 4.

The input unit 6 is constituted by, for example, a keyboard, a mouse, a microphone, or a camera. The output unit 5 is constituted by, for example, a liquid crystal display (LCD) or a speaker. When a command is input to the CPU 1 via the input/output interface 4 by a user operating the input unit 6, the CPU 1 executes a program stored in the ROM 2a. In addition, the CPU 1 loads a program stored in the hard disk 2c or a solid state drive (SSD, not illustrated) into the random access memory (RAM), reads and writes the program as necessary, and executes the program. As a result, the CPU 1 performs various types of processing and causes the information processing device 100 to function as a device having a predetermined function.

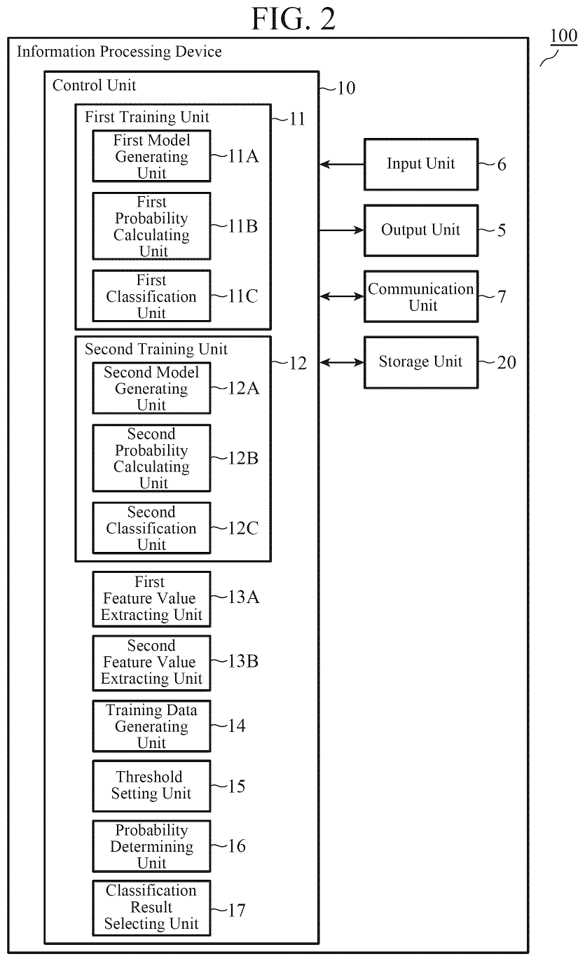

The CPU 1 outputs results of various types of processing via the input/output interface 4. For example, the CPU 1 outputs results of various types of processing from an output device which is the output unit 5. In addition, for example, the CPU 1 outputs (transmits) results of various types of processing from a communication device which is the communication unit 7 to an external device. In addition, for example, the CPU 1 outputs results of various types of processing to a storage unit 20 (see FIG. 2) such as the hard disk 2c and causes the storage unit 20 to record the results. For example, various types of information input from the input unit 6 and the communication unit 7 via the input/output interface 4 are recorded in the hard disk 2c. The CPU 1 calls and uses various types of information recorded in the hard disk 2c from the hard disk 2c as necessary.

For example, a program executed by the CPU 1 is recorded in advance in the hard disk 2c or the ROM 2a as a recording medium built in the information processing device 100. In addition, for example, the program executed by the CPU 1 is stored (recorded) in a removable recording medium 9 connected via the drive 8. Such a removable recording medium 9 may be provided as so-called package software. Examples of the removable recording medium 9 include a flexible disc, a compact disc read only memory (CD-ROM), a digital versatile disc (DVD), a magnetic disc, and a semiconductor memory.

In addition, for example, the program executed by the CPU 1 is transmitted and received via the communication unit 7 from a system (Comport) in which a plurality of pieces of hardware are connected to each other by wired and/or wireless connection, such as World Wide Web (WWW). In addition, for example, when the information processing device 100 performs training described later, a parameter obtained by the training, particularly, a weighting function in a neural network is transmitted and received by the above method.

For example, the CPU 1 functions as a machine learning device that performs calculation processing of machine learning. Note that such a machine learning device can be constituted by general-purpose hardware that excels in parallel calculation, such as a graphics processing unit (GPU), or can be constituted by dedicated hardware such as a field-programmable gate array (FPGA), in addition to a CPU.

In addition, the information processing device 100 may be constituted by a plurality of computers connected via a communication port, or may be implemented by hardware having different configurations in which training and inference described later are implemented independently of each other. In addition, the information processing device 100 may receive a single sensor signal or a plurality of sensor signals from an external sensor connected via a communication port. In addition, the information processing device 100 may prepare a plurality of virtual hardware environments in one piece of hardware, and each of the pieces of virtual hardware may be virtually handled as an individual piece of hardware.

Next, a function of the information processing device 100 will be described with reference to FIG. 2. FIG. 2 is a block diagram illustrating a configuration of the information processing device 100 according to the first embodiment. The information processing device 100 is configured to include a control unit 10, the input unit 6, the output unit 5, the communication unit 7, and a storage unit 20 according to the above-described hardware configuration.

Input data from the input unit 6, the communication unit 7, and the storage unit 20 is input to the control unit 10. The storage unit 20 is constituted by, for example, the ROM 2a, the RAM 2b, the hard disk 2c, the drive 8, or the like, and stores various types of data and information such as type information used by the information processing device 100 and a result calculated by the information processing device 100.

The control unit 10 includes a first training unit 11, a second training unit 12, a first feature value extracting unit 13A, a second feature value extracting unit 13B, a training data generating unit 14, a threshold setting unit 15, a probability determining unit 16, and a classification result selecting unit 17, and performs, by the first training unit 11, the second training unit 12, the first feature value extracting unit 13A, the second feature value extracting unit 13B, the training data generating unit 14, the threshold setting unit 15, the probability determining unit 16, and the classification result selecting unit 17, various types of processing on the basis of data input from the input unit 6 and the communication unit 7 and data and information acquired from the storage unit 20. For example, the control unit 10 outputs results of various types of processing to the outside of the unit via the output unit 5 and the communication unit 7. In addition, for example, the control unit 10 causes the storage unit 20 to store the results of various types of processing. Note that the input unit 6, the communication unit 7, and the storage unit 20 constitute an input unit in the first embodiment. The output unit 5, the communication unit 7, and the storage unit 20 constitute an output unit in the first embodiment.

The first training unit 11 and the second training unit 12 perform training on the basis of input data from the input unit 6, the communication unit 7, and the storage unit 20, perform inference on the input data from the input unit 6, the communication unit 7, and the storage unit 20 in a state where training is performed, and classify the input data into any one of a plurality of classes. The first feature value extracting unit 13A and the second feature value extracting unit 13B extract a feature value of the input data from the input unit 6, the communication unit 7, and the storage unit 20. In other words, the first feature value extracting unit 13A and the second feature value extracting unit 13B quantify a feature of the input data from the input unit 6, the communication unit 7, and the storage unit 20. In addition, the first feature value extracting unit 13A and the second feature value extracting unit 13B extract different feature values of the input data.

The training data generating unit 14 generates training data for the second training unit 12 to perform training on the basis of the training data for the first training unit 11 to perform training, input from the input unit 6, the communication unit 7, and the storage unit 20. The threshold setting unit 15 sets a threshold to be referred to when the control unit 10 performs predetermined processing. The probability determining unit 16 determines whether a probability of inference when the first training unit 11 performs inference is equal to or less than a threshold set by the threshold setting unit 15 or exceeds the threshold. The classification result selecting unit 17 selects and outputs either a classification result by the first training unit 11 or a classification result by the second training unit 12 on the basis of a determination result by the probability determining unit 16. Details of the training data generating unit 14, the threshold setting unit 15, the probability determining unit 16, and the classification result selecting unit 17 will be described later.

The first training unit 11 includes a first model generating unit 11A, a first probability calculating unit 11B, and a first classification unit 11C. The first model generating unit 11A performs training on the basis of input data from the input unit 6, the communication unit 7, and the storage unit 20, and generates a first trained model.

The first probability calculating unit 11B performs inference (identification) on the input data from the input unit 6, the communication unit 7, and the storage unit 20 on the basis of a feature value extracted by the first feature value extracting unit 13A and the first trained model, and calculates a probability with which the input data is classified into each of a plurality of classes set in advance by the first trained model. Note that, in the first embodiment, the probability with which the input data is classified into each of a plurality of classes set in advance by the trained model is also referred to as a probability of inference. For example, in a classification problem into three classes, three numbers are obtained by inputting the input data to the trained model. The three numbers are, for example, 0.3, 0.6, and 0.1, and in the present embodiment, each of these numbers is referred to as a probability of inference. In this example, normalization is performed in such a manner that the sum of the probabilities is 1, but the sum does not necessarily need to be 1. The first classification unit 11C classifies the input data from the input unit 6, the communication unit 7, and the storage unit 20 into at least one class of a plurality of classes set in advance by the first trained model on the basis of the probability of inference calculated by the first probability calculating unit 11B.

The second training unit 12 includes a second model generating unit 12A, a second probability calculating unit 12B, and a second classification unit 12C. The second model generating unit 12A performs training on the basis of input data from the input unit 6, the communication unit 7, and the storage unit 20, and generates a second trained model.

The second probability calculating unit 12B performs inference (identification) on the input data from the input unit 6, the communication unit 7, and the storage unit 20 on the basis of a feature value extracted by the second feature value extracting unit 13B and the second trained model, and calculates a probability (probability of inference) with which the input data is classified into each of a plurality of classes set in advance by the second trained model. The second classification unit 12C classifies the input data from the input unit 6, the communication unit 7, and the storage unit 20 into any one of a plurality of classes set in advance by the second trained model on the basis of the probability of inference calculated by the second probability calculating unit 12B.

As described above, the first training unit 11 and the second training unit 12 function as training devices that generate a trained model by performing training on the basis of training data input from the input unit 6, the communication unit 7, and the storage unit 20, and classifies the input data from the input unit 6, the communication unit 7, and the storage unit 20 by performing inference on the input data on the basis of the generated trained model.

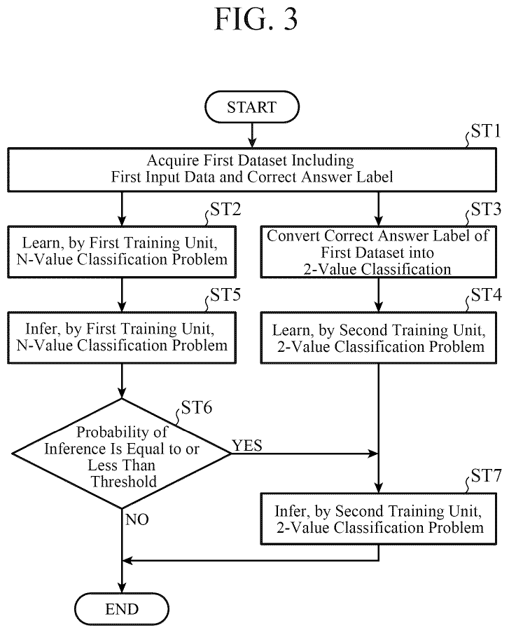

Next, an outline of processing performed by the information processing device 100 will be described with reference to FIGS. 2 and 3. FIG. 3 is a flowchart illustrating processing performed by the information processing device 100 according to the first embodiment. The processing performed by the information processing device 100 can be divided into processing of performing training and processing of performing inference.

First, an outline of training will be described. When performing training, the information processing device 100 acquires a first dataset including training data that is a plurality of pieces of first input data and a correct answer label of an N-value classification (first number classification) problem associated with each of the plurality of pieces of training data (step ST1). In other words, when performing training, the information processing device 100 acquires a first dataset including a plurality of correct answer labels corresponding to a plurality of classes and training data that is a plurality of pieces of input data associated with the respective plurality of correct answer labels. Note that N as the first number is a predetermined natural number satisfying 3≤N. In addition, when performing training, the information processing device 100 may acquire the first dataset via the input unit 6 and the communication unit 7 each time, or may read and use data acquired in advance and stored in the storage unit 20.

After performing the processing of step ST1, the information processing device 100 learns, by the first model generating unit 11A, the N-value classification problem and generates the first trained model. In addition, after performing the processing of step ST1, the information processing device 100 re-assigns, by the training data generating unit 14, a correct answer label of the first dataset in such a manner that M-value classification (second number classification) in which the number of classes is different from that of N-value classification is obtained, and creates a second dataset (step ST3). In other words, the information processing device 100 re-assigns, by the training data generating unit 14, a correct answer label of the first dataset in such a manner that M-value classification (second number classification) in which the number of classes is M (second number) is obtained, and creates a second dataset. In the first embodiment, the correct answer label is re-assigned in such a manner that a correct answer label of the first dataset is 2-value classification, and the second dataset is generated. Note that M as the second number only needs to be a predetermined natural number satisfying M≤N.

After performing the processing of step ST3, the information processing device 100 learns, by the second model generating unit 12A, the 2-value classification using the generated second dataset, and generates a second trained model (step ST4). Note that the second trained model may be a single trained model that outputs one result for one piece of input data, or may be constituted by a plurality of trained models in such a manner as to output a plurality of results for one piece of input data.

Next, an outline of inference will be described. After performing the processing of step ST2, the information processing device 100 performs, by the first training unit 11, inference on unknown input data (for example, test data) not included in the first dataset (step ST5). The information processing device 100 performs, by the first probability calculating unit 11B, inference, and calculates a probability of inference of the input test data for each of N values (classes). In this processing, the information processing device 100 classifies, by the first classification unit 11C, the input data into a class (first class) having the highest probability of inference among N (first number) classes that are inference candidates (classification candidates) of the input data. Note that, in the following description, a class having the highest probability of inference is also referred to as a first inference candidate, and a class (second class) having the second highest probability of inference is also referred to as a second inference candidate. In addition, the present embodiment can also be applied to one having two or more correct answer labels for one piece of input data, such as MultiMNIST which is one of datasets, and in a case where it is known that two correct answer labels are included, a first inference candidate and a second inference candidate are used as inference values, and a label corresponding to the inference value is used as an inference label. Note that, in a case where there is a plurality of correct answer labels, processing is similar to that in a case of one correct answer label, and therefore, in the present embodiment, a case where there is one correct answer label will be described.

After performing the processing of step ST5, the information processing device 100 determines, by the probability determining unit 16, whether the probability of the first inference candidate is equal to or less than a threshold set in advance by the threshold setting unit 15 (step ST6).

In the processing of step ST6, if the probability of inference of the first inference candidate exceeds the threshold (NO in step ST6), the information processing device 100 selects, by the classification result selecting unit 17, to output a classification result by the first classification unit 11C, that is, a value of a class that is the first inference candidate by the first classification unit 11C out of the classification result by the first classification unit 11C and a classification result by the second classification unit 12C.

In addition, in the processing of step ST6, if the probability of inference of the first inference candidate is equal to or less than the threshold (YES in step ST6), the information processing device 100 selects to output the classification result by the second classification unit 12C out of the classification result by the first classification unit 11C and the classification result by the second classification unit 12C, and performs, by the second probability calculating unit 12B, inference of 2-value classification on the input data and calculates a probability of inference for each of the two classes. Furthermore, the information processing device 100 classifies, by the second classification unit 12C, the input data into a class having a higher probability of inference out of the two classes that are inference candidates of the input data. This value is output as a classification result and an inference result. After performing the processing of either step ST6 or ST7, the information processing device 100 outputs either the classification result by the first classification unit 11C or the classification result by the second classification unit 12C from the control unit 10 to any one of the output unit 5, the communication unit 7, and the storage unit 20 on the basis of a selection result by the classification result selecting unit 17.

Note that, in the processing of step ST6, the information processing device 100 determines, by the probability determining unit 16, whether the probability of inference by the first training unit 11 is equal to or less than the threshold, but it is not limited thereto. The information processing device only needs to be able to determine, by the probability determining unit, whether the probability of inference by the first training unit is larger or smaller than the threshold, may determine whether the probability of inference by the first training unit is less than the threshold, may determine whether the probability of inference by the first training unit is equal to or more than the threshold, or may determine whether the probability of inference by the first training unit exceeds the threshold.

Note that the information processing device 100 of the first embodiment performs processing using the probability of inference and the threshold, both of which are positive values, but it is not limited thereto. In a case where the probability of inference and the threshold calculated are negative values, the information processing device may be configured to output an inference result on the basis of inference by the first training unit when the probability of inference by the first training unit exceeds the threshold, and to output an inference result on the basis of inference by the second training unit when the probability of inference by the first training unit is equal to or less than the threshold in the processing performed by the probability determining unit. Although a method for setting the threshold by the threshold setting unit 15 will be described later, for example, the information processing device 100 performs statistical processing on a result of correct inference and a result of incorrect inference, and sets a value therebetween as the threshold.

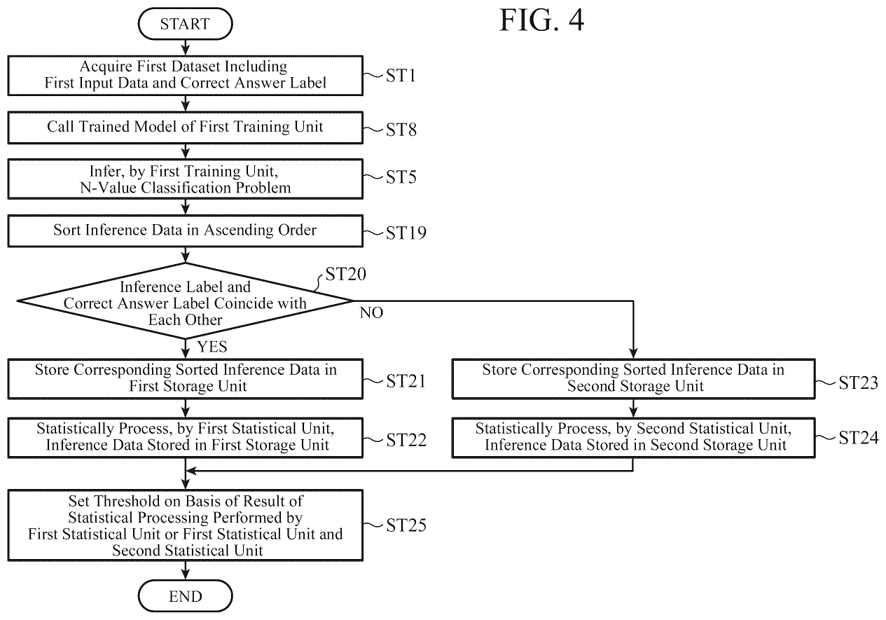

Next, the threshold will be described with reference to FIG. 4. FIG. 4 is a flowchart illustrating processing of setting the threshold, performed by the information processing device 100.

As illustrated in FIG. 4, the information processing device 100 performs, by the first classification unit 11C, a first process of rearranging input data in such a manner that a probability calculated by the first probability calculating unit 11B is in ascending or descending order, a second process of extracting a label having a maximum probability from the rearranged input data, a third process of comparing the label having the maximum probability with a correct answer label associated with the input data, a first storage process of storing a class obtained in the first process, in which the labels coincide with each other as a comparison result of the third process, a second storage process of storing a class obtained in the first process, in which the labels do not coincide with each other as a comparison result of the third process, a first statistical process of statistically processing the class stored by the first storage process, and a second statistical process of statistically processing the class stored by the second storage process. The threshold setting unit 15 sets a threshold set between a first statistical value calculated by the first statistical process and a second statistical value calculated by the second statistical process, and the first classification unit 11C classifies input data on the basis of a comparison result between a probability calculated by the first probability calculating unit 11B and the threshold. The first statistical process and the second statistical process are, for example, processing of calculating any one of an average value, a median value, a standard deviation, and information entropy. Note that the first statistical process and the second statistical process may be, for example, processing of calculating any two or more of an average value, a median value, a standard deviation, and information entropy in combination. The second process is, for example, processing of extracting a label having a minimum value, and the third process is, for example, processing of comparing the label having the minimum value with a correct answer label associated with input data.

Specifically, the information processing device 100 first acquires a first dataset including a plurality of pieces of first input data and a correct answer label of an N-value classification problem associated with each of the plurality of pieces of first input data (step ST1). After performing the processing of step ST1, the information processing device 100 refers to information stored in the storage unit 20, calls the first trained model on which inference is to be performed by the first training unit 11 (step ST8), infers, by the first training unit 11, an N-value classification problem for the input first input data, and calculates a probability of inference for each of pieces of the first input data (step ST5). For example, in the processing of step ST5, the information processing device 100 calculates a probability of inference for a plurality of pieces of input data not used for generation of the first trained model.

After performing the processing of step ST5, the information processing device 100 rearranges the inferred inference data in such a manner that the calculated probability is in ascending or descending order (first process, step ST19). In other words, the information processing device 100 sorts the inferred inference data in such a manner that the calculated probability is in ascending or descending order. After performing the processing of step ST19, the information processing device 100 extracts a label (inference label) having a maximum probability for each piece of the sorted inference data (second process), and determines whether or not the extracted inference label coincides with a correct answer label (third process, step ST20).

In the processing of step ST20, if the inference label coincides with the correct answer label (YES in step ST20), the corresponding sorted inference data is stored in a first storage unit included in the storage unit 20 (first storage process, step ST21). After performing the processing of step ST22, the information processing device 100 statistically processes, by a first statistical unit included in the threshold setting unit 15, the sorted inference data stored in the first storage unit (first statistical process, step ST22).

In the processing of step ST20, if the inference label does not coincide with the correct answer label (NO in step ST20), the corresponding sorted inference data is stored in a second storage unit included in the storage unit 20 (second storage process, step ST23). After performing the processing of step ST23, the information processing device 100 statistically processes, by a second statistical unit included in the threshold setting unit 15, the sorted inference data stored in the second storage unit (second statistical process, step ST24).

After performing the processing of steps ST22 and ST24, the information processing device 100 sets a threshold on the basis of results of the statistical processing (step ST25).

In addition, for example, the threshold setting unit 15 sets the threshold to be equal to or less than the first statistical value calculated by the first statistical process. As a result, it is possible to determine that a value equal to or more than the first statistical value serving as the threshold has a sufficiently high probability, and does not need to be analyzed. Therefore, the threshold can be narrowed down. Furthermore, the threshold setting unit 15 sets the threshold between the first statistical value calculated by the first statistical process and the second statistical value calculated by the second statistical process. In other words, the threshold setting unit 15 sets the threshold to be equal to or less than the first statistical value calculated by the first statistical process and equal to or more than the second statistical value calculated by the second statistical process. As a result, it can be determined that a value equal to or more than the first statistical value serving as the threshold has a sufficiently high probability, and it can be determined that it is highly likely to be difficult to classify a value equal to or less than the second statistical value regardless of a method used. Therefore, a range in which the threshold is narrowed down can be narrowed. In addition, for example, the threshold setting unit 15 sets the threshold to be an average value of the first statistical value and the second statistical value. In addition, for example, the threshold setting unit 15 sets the threshold to be a weighted average value using the number of pieces of input data assigned to the first statistical value and the second statistical value as a weight. Furthermore, the threshold setting unit 15 may determine, as the threshold, a condition that does not satisfy all the values by using both an average value and a weighted average of the first statistical values or a combination of a standard deviation and a median value other than the average, or may determine, as the threshold, a value between each of the first statistical values and each of the second statistical values by using both an average value and a weighted average of each of the first statistical values and the second statistical values, or a combination of a standard deviation and a median value other than the average.

For example, when the highest probability among probabilities with which input data is classified into the first number of classes, calculated by the first probability calculating unit is defined as a fifth probability, the threshold setting unit 15 may set the threshold to be a value between one of an average value and a median value of the fifth probability when a result that coincides with a class corresponding to the correct answer label is obtained and one of an average value and a median value of the fifth probability when a result that does not coincide with the class corresponding to the correct answer label is obtained among results obtained by the first classification unit classifying the plurality of pieces of input data of the first dataset.

In addition, the threshold setting unit 15 may set the threshold to be a value between an average value of the fifth probability when a result that coincides with a class corresponding to the correct answer label is obtained among results obtained by the first classification unit classifying a plurality of pieces of input data of the first dataset and an average value of the fifth probability when a result that does not coincide with the class corresponding to the correct answer label is obtained among the results obtained by the first classification unit classifying the plurality of pieces of input data of the first dataset, and between a median value of the fifth probability when a result that coincides with the class corresponding to the correct answer label is obtained among the results obtained by the first classification unit classifying a plurality of pieces of input data of the first dataset and a median value of the fifth probability when a result that does not coincide with the class corresponding to the correct answer label is obtained among the results obtained by the first classification unit classifying the plurality of pieces of input data of the first dataset.

In addition, when the second highest probability (or a probability of any class whose probability is the second highest or lower) among probabilities with which input data is classified into the first number of classes, calculated by the first probability calculating unit is defined as a sixth probability, the threshold setting unit 15 may set the threshold to be a value between one of an average value and a median value of the sixth probability when a result that coincides with a class corresponding to a correct answer label is obtained among results obtained by the first classification unit classifying the plurality of pieces of input data of the first dataset and one of an average value and a median value of the sixth probability when a result that does not coincide with the class corresponding to the correct answer label is obtained among results obtained by the first classification unit classifying the plurality of pieces of input data of the first dataset.

In addition, the threshold setting unit 15 may set the threshold to be a value between one of an average value and a median value of the fifth probability when a result that coincides with a class corresponding to the correct answer label is obtained among results obtained by the first classification unit classifying a plurality of pieces of input data of the first dataset and one of an average value and a median value of the sixth probability when a result that coincides with a class corresponding to the correct answer label is obtained among the results obtained by the first classification unit classifying the plurality of pieces of input data of the first dataset, and between one of an average value and a median value of the fifth probability when a result that does not coincide with the class corresponding to the correct answer label is obtained among the results obtained by the first classification unit classifying a plurality of pieces of input data of the first dataset and one of an average value and a median value of the sixth probability when a result that does not coincide with the class corresponding to the correct answer label is obtained among the results obtained by the first classification unit classifying the plurality of pieces of input data of the first dataset.

In addition, the threshold setting unit 15 may set the threshold for each subset of pieces of input data included in the first dataset, or may set the threshold for each of a plurality of classes into which the first classification unit classifies the input data.

In addition, for example, in a case where a value of a label extracted in the second process, to be compared with the threshold set by the threshold setting unit 15, is equal to or less than the threshold, the information processing device 100 performs, by the second classification unit 12C, inference using the second feature value extracting unit 13B. In addition, for example, in a case where a maximum probability in the second process for the input data is equal to or less than the threshold set by the threshold setting unit 15, the information processing device 100 performs, by the second classification unit 12C, inference using the second feature value extracting unit.

Since conditions of the threshold can be narrowed down by the above method, the threshold can be obtained by a method that does not rely on empirical rules. In addition, since a search range is narrowed also in a case where trial and error (parameter sweep) is performed for the purpose of further optimization, an optimum value can be reached with a small number of trials. Furthermore, this method does not depend on machine learning to be used or input data to be used, and therefore can determine an appropriate probability regardless of what is used.

It has become apparent from the present invention that data having a small maximum probability tends to be erroneous regardless of the size of a dataset. By setting a threshold for the probability, even when training is performed with a small dataset, it is possible to remove data having a low probability, and therefore, it is possible to obtain an effect of enhancing inference accuracy. Furthermore, in addition to the removal, by using the information processing device capable of obtaining a higher probability, it is possible to perform inference with a high probability, and as a result, it is possible to obtain an effect of being able to enhance inference accuracy.

### <Data Used for First Training Unit>

Next, training and inference of the first dataset and the first training unit 11 and training and inference of the second dataset and the second training unit 12 will be sequentially described.

Data input to the information processing device 100 is, for example, an image, a graph, a text, and a time waveform. The information processing device 100 processes the input data as a multi-value classification problem, that is, an N-value classification problem, and outputs a classification result. The multi-value classification is, for example, an example of classification using machine learning that infers (identifies) which value of 10 values from 0 to 9 the input data is with a trained model and outputs an inference result (a classification result and an identification result).

Training data used by the information processing device 100 in the machine learning is supervised data. The supervised data has one or more classification values for each of a plurality of pieces of input data. In the first embodiment, a classification value for the supervised data is referred to as a correct answer label. For example, a correct answer label of “handwritten character 5” in Modified National Institute of Standards and Technology database (MNIST) is “5”. A set of the training data and the correct answer label is referred to as a dataset.

Next, the correct answer label will be described. In a case of 10-value classification, integers from 0 to 9 are generally used as the correct answer labels, but the correct answer labels are not limited to integers that are continuous or start from 0. In addition, like One Hot Vector, a method in which 1 is put only at a corresponding correct answer label, such as (1, 0, 0) for the above 1, (0, 1, 0) for the above 2, or (0, 0, 1) for the above 3, is also effective. For example, when 10-value classification is performed, the correct answer label may be defined by a matrix of 10×10. In addition, in the first embodiment, description will be given using the 10-value classification for ease of understanding. However, the classification performed by the information processing device only needs to be N-value classification (3≤N), and may be, for example, classification of a dataset having 20,000 correct answer labels for 14 million pieces of input data, like ImageNet which is a dataset famous for image recognition. In addition, in a regression problem different from the classification problem, in a case where a range of a correct answer label of regression is, for example, a real number from 0 to 100, the regression problem can be applied to the information processing device 100 by converting the correct answer label into 100 discrete values such as 0 to 1, 1 to 2, . . . , and 99 to 100 and thereby converting the regression problem into a classification problem that performs classification into three or more values.

Next, the information processing device 100 will be described. The information processing device 100 of the first embodiment has a configuration of classifying input data into N values. The information processing device 100 may be any one of different algorithms of deep learning having a configuration of classifying input data into N values, a gradient boosting method, a support vector machine, logistic regression, a k-nearest neighbor algorithm, a decision tree, simple Bayes, and the like, or a combination thereof.

In the first embodiment, deep learning that has high inference accuracy (probability of inference) and is an example of desirable training will be described as an example of training performed by the information processing device. As an algorithm of deep learning, various algorithms are known depending on input data. For example, if the input data is image data, algorithms such as a convolutional neural network (CNN), a multi-layer perceptron (MLP), and Transformer are known. Furthermore, algorithms such as Vgg, ResNet, DenseNet, MobileNet, and EfficientNet, which have a common point that convolution is performed also in CNN, are known. In addition, a combination of pure full connections and an algorithm such as an MLP-Mixer are known also in MLP, and an algorithm combined with feature value extraction of CNN and an algorithm such as Vision Transformer are known also in Transformer. The information processing device may use these methods singly or in combination thereof. In the first embodiment, the first training unit 11 and the second training unit 12 will be described. The first training unit and the second training unit may be algorithms different from each other, and the second training unit may be constituted by two or more devices, each of which may use two or more types of algorithms different from each other.

Next, presence or absence of training will be described. The information processing device 100 performs training and inference using a training dataset. In the first embodiment, training refers to processing of optimizing an internal parameter of the information processing device 100, and inference refers to performing calculation on data input on the basis of an optimized parameter.

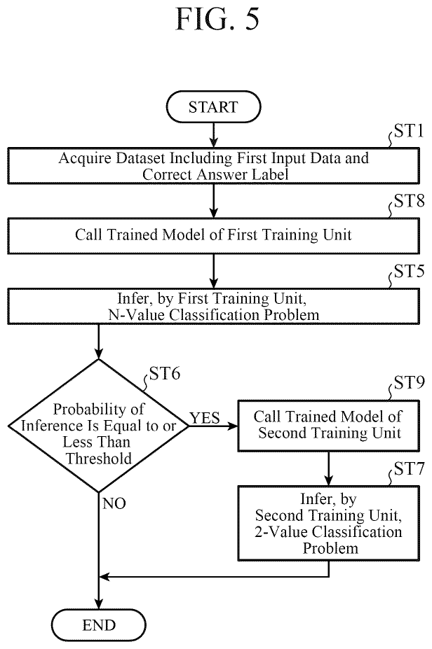

FIG. 5 is a flowchart illustrating a modification of processing performed by the information processing device 100 according to the first embodiment. For example, after performing the processing of step ST1, the information processing device 100 may refer to information stored in the storage unit 20, may call a trained model on which inference is to be performed by the first training unit 11 (step ST8), and may infer, by the first training unit 11, an N-value classification problem for the input data (step ST5).

In addition, if the probability calculated by the first training unit 11 in the processing of step ST5 is equal to or less than the threshold (YES in step ST6), the information processing device 100 may refer to information stored in the storage unit 20, may call a trained model on which inference is to be performed by the second training unit 12 (step ST9), and may infer, by the second training unit 12, a 2-value classification problem for the input data (step ST7). In this manner, the information processing device 100 may store the trained model in the storage unit 20 in advance, may call the trained model as necessary, and may perform inference.

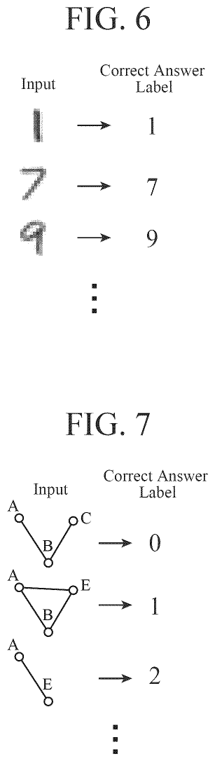

Next, data input to the information processing device 100 and a classification problem processed in the information processing device 100 will be described with reference to FIGS. 6 to 9. FIG. 6 is a diagram illustrating an example of a dataset of an image input to the information processing device 100. An image as illustrated on the left side of FIG. 6 may be a still image or a moving image. Since a moving image can be considered as a continuous combination of still images, in the first embodiment, a case where still image data is input to the information processing device 100 will be described.

The still image data input to the information processing device 100 may be a color image constituted by a combination of two or more channels such as RGB, or may be a monochrome image constituted by one channel. Note that, although various types of processing are known depending on a difference in algorithm of the information processing device 100 as processing in a case where there is a plurality of channels, in general, the channels are combined into one channel by a weight matrix for combining the channels.

The size of image data input to the information processing device 100 may be image data of 32 pixels×32 pixels, as in MNIST or Canadian Institute For Advanced Research 10 (CIFAR10), may be image data of 96 pixels×96 pixels, as in STL10, may be image data of another size, or may be image data other than a square. Note that the smaller the size of the image data input to the information processing device 100, the shorter a calculation time.

The input image data may be a sensor signal obtained by converting physical data into numerical data by, for example, a device that captures an electromagnetic wave, such as a charge coupled device (CCD) camera, a complementary MOS (CMOS) camera, an infrared camera, an ultrasonic measuring device, or an antenna, or may be a graphic created on a computer using a computer aided design (CAD) or the like.

FIG. 7 is a diagram illustrating an example of a dataset of a graph input to the information processing device 100. A plurality of problem settings can be considered for a classification problem in the graph illustrated on the left side of FIG. 7. The graph includes a node that is a point and an edge that is a line connecting the points, and the node and the edge have any graph information. For example, as a main classification problem in such a graph, there are a problem of classifying nodes from an edge and graph information, a problem of classifying edges from a node and graph information, and a problem of classifying graphs by training a plurality of graphs.

For example, an electric circuit can be represented as a graph. For example, as the problem of classifying nodes, when data input to the information processing device is represented as a circuit diagram and data output from the information processing device is represented as an output voltage between any terminals of the circuit, a problem of selecting a circuit component in such a manner as to obtain a desired output voltage can be considered. For example, since there are a finite number of capacitors, coils, diodes, resistors, and the like as circuit components, the problem of selecting a circuit component in such a manner as to obtain a desired output voltage in the electric circuit can be handled as a classification problem.

In addition, for example, as the problem of classifying edges, in a circuit diagram including all necessary components, when an arrangement position of a component is represented by a node of a graph and wire connecting the components is represented by an edge of the graph, a problem of optimizing the wire connecting the components can be handled as a classification problem. In order for the information processing device 100 of the first embodiment to perform classification, two or more nodes are required, but when there are two or more components, it can be handled as a multi-value classification problem. In addition, for example, a problem of classifying a graph obtained as one circuit diagram into any one of a step-up power supply circuit, a step-down power supply circuit, a step-up/step-down power supply circuit, an isolated circuit, and a non-isolated circuit, or a problem of classifying the graph into any one of a power supply circuit, a sensor circuit, a communication circuit, and a control circuit can be handled as a problem of classifying graphs.

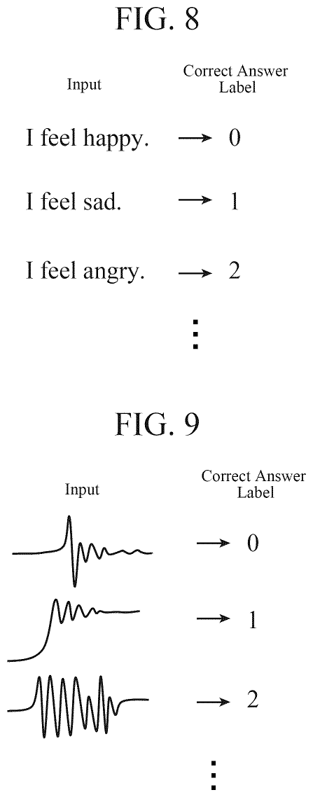

FIG. 8 is a diagram illustrating an example of a dataset of a natural language input to the information processing device 100. In the classification problem for classifying a natural language as illustrated on the left side of FIG. 8, a case where what is obtained by cutting out a part of a block of text, such as one sentence, one paragraph, one clause, or the entire text, is given as input data is conceivable. For example, when a certain news article is given, a problem of inferring into which of economy, politics, sports, and science the news article is classified is a classification problem.

Such a classification problem may be a classification problem evaluated in one sentence or one paragraph, may be, for example, a classification problem in which one novel is given and the author and the genre of the novel are inferred, may be a problem in which a source code of a program language, a G code of NC milling, and the like are classified into functions, or may be a problem in which a given sentence is classified into delight, anger, sorrow, and pleasure and emotions is analyzed.

FIG. 9 is a diagram illustrating an example of a dataset of a time waveform of a signal input to the information processing device 100. A classification problem of classifying a time waveform, which is a set of continuously changing numerical values including time-series data illustrated on the left side of FIG. 9, classifies a time waveform of a signal having, for example, a horizontal axis as time and a vertical axis as any physical information such as voltage or peak value, the time waveform serving as input data. For example, a problem of classifying an electric circuit into any one of a power supply circuit, a sensor circuit, a communication circuit, and a control circuit on the basis of a time waveform of a signal in the electric circuit, the time waveform serving as input data, can be handled as a classification problem. In addition, the horizontal axis of data input to the information processing device 100 is not limited to time, but any feature value such as frequency or coordinates may be used as long as the feature value has a physical spread.

The example of the data input to the information processing device 100 has been described above. The data input to the information processing device 100 may be any data as long as the data can be input to artificial intelligence (AI) and an output thereof can be converted into a form obtained as a classification result, such as an iris dataset that is classified four types of numerical feature values into three types or a numerical dataset.

Next, processing performed by the information processing device 100 on input data immediately before an output layer of deep learning will be described. In deep learning, information processing is performed on input data such as the above-described image or graph. At this time, the information processing device 100 performs processing by full connection or a nonlinear function in the processing immediately before the output. The processing of full connection is performed in order to collectively aggregate results of extracting feature values from input data by convolution calculation or the like into a desired classification number. In general, a result of processing using an activation function that is a non-linear function, for example, a softmax function, is output after the processing of full connection.

Note that the processing of full connection is not necessarily required, and the information processing device may aggregate the feature values into a desired classification number at a stage of extraction of the feature values described below although inference accuracy is often somewhat deteriorated. For example, the information processing device may compare an inference value obtained by outputting a processing result of the full connection or extracting the feature value with a correct answer label. In addition, in general, by performing processing using a softmax function, a clear difference is generated between inference candidates, and improvement in inference accuracy is expected. Therefore, the information processing device desirably performs processing using a softmax function on input data. Note that the information processing device may perform processing using, instead of the softmax function, a nonlinear function obtained by modifying the softmax function, such as log-softmax, on input data.

Next, an example of processing in which the information processing device 100 extracts a feature value for various pieces of input data will be described. In a case where data input to the information processing device 100 is image data, as described above, a convolutional neural network (CNN), a multi-layer perceptron (MLP), or Transformer is often used when a feature value is extracted. Note that it is also possible to process an image by a graph neural network (GNN) used in a graph theory described below, a relational neural network (RNN) used for time-series processing, or a technique applying these.

Deep learning has been described above, and the information processing device 100 may use logistics regression, a support vector machine, a gradient boosting method, or the like, and various algorithms are conceivable as algorithms thereof. In particular, various algorithms are known in deep learning, and the information processing device may use algorithms such as Vgg, ResNet, AlexNet, MobileNet, and EfficientNet.

In addition, the information processing device can process an image only by pure full connection also in MLP, but a method such as MLP-Mixer utilizing MLP is known, and these methods may be used. In addition, also in Transformer, Vision Transformer, a method obtained by combining Transformer and feature value extraction of CNN, and the like are known, and the information processing device may use these methods singly or in combination thereof.

As graph data, the information processing device 100 uses a graph neural network (GNN), a graph convolutional network (GCN) that convolves a nearby node, or the like Since coordinates of graph data cannot be defined unlike image data, graph data cannot be directly input to deep learning.

Therefore, in a case where data input to the information processing device 100 is graph data, the graph data is input after being subjected to transformation with an adjacent matrix or an order matrix, which is a reversible transformation. Here, the adjacent matrix expresses presence or absence of connection between nodes of a graph by a matrix, and is an N×N matrix in a case where there are N nodes. In addition, the adjacent matrix is a symmetric matrix in a case where a graph is an undirected graph having no edge orientation, and is an asymmetric matrix in a case where the graph is a directed graph.

The order matrix expresses the number of edges included in each node by a matrix, and is an N×N matrix and is a diagonal matrix in a case where there are N nodes. The information processing device converts the input graph data into matrix data, inputs the matrix data to GNN, GCN, or the like, performs training through a plurality of hidden layers, performs processing using full connection, a softmax function, or the like before an output layer, and outputs the data. A method therefor is similar to the deep learning in the above-described image, and therefore description thereof is omitted. In general, in deep learning, in a case where input data is data of a time waveform, an RNN is often used, and a gated recurrent unit (GRU) obtained by extending the RNN and a long short-term memory (LSTM) are main techniques.

In addition to these, a combination of Transformer and a technique using an Attention mechanism that is a source of Transformer, a temporal convolutional network (TCN) using discrete one-dimensional convolution, and the like are known. By using these techniques for input data, the data can be input to deep learning. Regarding an output, the information processing device 100 extracts a feature value of the input data by the method described above, then performs processing using full connection, a softmax function, or the like before an output layer, and outputs the data. A method therefor is similar to the deep learning in the above-described image, and therefore description thereof is omitted.

In a case where the data input to the information processing device 100 is data in a natural language, an LSTM that handles the time waveform, a technique called sequence to sequence (Seq2Seq) that is an evolved system of the LSTM, an Attention mechanism that is an evolved system of the Seq2Seq, and Transformer technique that is an evolved system of the Attention mechanism are known, and the information processing device 100 can classify natural language data by using these techniques.

Conventionally, the LSTM can predict a language from a context of text, but only a signal having a fixed length can be handled, and thus inference accuracy varies depending on the length of text. However, the above-described problem is solved by using the concept of Encoder-Decoder for the Seq2Seq in the LSTM.

Note that this method has insufficient inference accuracy, and Attention is obtained by introducing a probability between words constituting text and improving the inference accuracy. However, Attention cannot perform parallelization, and cannot handle a large-scale dataset. Therefore, Transformer is a method in which parallelization in Attention can be performed using dedicated hardware such as a GPU. Transformer has a difference in inference accuracy and calculation time, but has a common original technique, and therefore the information processing device 100 may use any of these methods. Regarding an output, the information processing device 100 extracts a feature value of the input data by the method described above, then performs processing using full connection, a softmax function, or the like before an output layer, and outputs the data. A method therefor is similar to the deep learning in the above-described image, and therefore description thereof is omitted.

Next, the number of pieces of data input to the information processing device 100 will be described.

The number of pieces of data such as images, graphs, time waveforms, and texts input to the information processing device 100 is desirably 100 or more, and more desirably 1,000 or more for each correct answer label. In addition, a training dataset input to the information processing device 100 is not desirably a dataset in which variance of similar data is small in one correct answer label, and is desirably a dataset having a distribution that can include a result expected at the time of inference.

In a case where the data input to the information processing device 100 is image data, “data augmentation” that increases training data by affine transformation or the like can be performed. However, augmentation cannot be used for any data. For example, in a case where the data input to the information processing device 100 is data of a graph, a text, and a time waveform, it is generally difficult to perform the above-described data augmentation.

In a case where the number of pieces of data used for training is small, the information processing device 100 can improve inference accuracy by performing training using a similar dataset that can obtain more data or using a dataset of a time waveform acquired more by a similar sensor. In addition, the information processing device 100 may perform training by transfer learning or fine tuning with less acquired data using a variable and a weight matrix obtained by training as initial values. In a case where training is performed in this manner, the number of pieces of data input to the information processing device 100 may be 100 or less.

Note that transfer learning is training of changing an element of a variable or a weight matrix serving as an initial value in such a manner that a learning ratio is decreased, and fine tuning is a method for training only full connection by fixing a variable or a weight matrix. In general, transfer learning and fine tuning are often used in combination, and the information processing device 100 may be configured to first attempt fine tuning a plurality of times, optimize a parameter, and then attempt transfer learning at the time of repeated calculation. In addition, in such a case, not all variables and weight matrices are necessarily required to be initial values, and only some variables, some weight matrices, and some parameters may be shared.

Although the case where the information processing device 100 performs supervised learning has been described above, the information processing device 100 may perform semi-supervised learning. In a case where the information processing device 100 performs semi-supervised learning, there is a disadvantage that bias is generated in training and inference accuracy decreases due to a smaller amount of data having a correct answer label than in a case of supervised learning. Therefore, the information processing device 100 may be capable of performing training by a method for performing training by unsupervised learning and giving a correct answer later, such as self-supervised learning called contrastive learning. Also in this case, there are desirably 1,000 or more pieces of training data having no correct answer label for each correct answer label, and there are desirably 100 or more pieces of training data having a correct answer label.

Next, a first dataset including data such as the above-described image, graph, text, and time series, and a method for using the information processing device 100 will be described. In the first embodiment, the information processing device 100 performs processing of an N-value classification problem when N is an integer of 3 or more. An upper limit of N is not particularly limited, but as N increases, a larger-scale dataset is required for training by the information processing device 100, and a calculation amount required for training also increases. Therefore, N is desirably as small as possible. The dataset is divided into training data, verification data, and test data for each correct answer label, or is simply divided into training data and test data.

For example, Modified National Institute of Standards and Technology database (MNIST) includes 60,000 pieces of training data and 10,000 pieces of test data, and the information processing device 100 may use all of these as the training data, or may use 50,000 pieces of data as the training data and 10,000 pieces of data as the verification data, for example.

Note that the data used for training desirably includes almost the same number of pieces of training data, verification data, and test data for each of the N correct answer labels, and is desirably selected at random in such a manner as not to generate bias depending on the correct answer label. In addition, in a case where a part of the data is used as the verification data, the information processing device 100 may first perform training with the training data, and confirm inference accuracy based on the verification data by using data that has not been used for training as the verification data. In this way, it is possible to prevent training performed by the information processing device 100 from being over-training for the test data. Note that, in a case where a part of the data is used as the verification data, since data usable as the test data is reduced, the inference accuracy for the test data is likely to decrease, and it is desirable to use the data differently depending on the size or the like of a dataset that can be prepared.

### <Learning by First Training Unit>

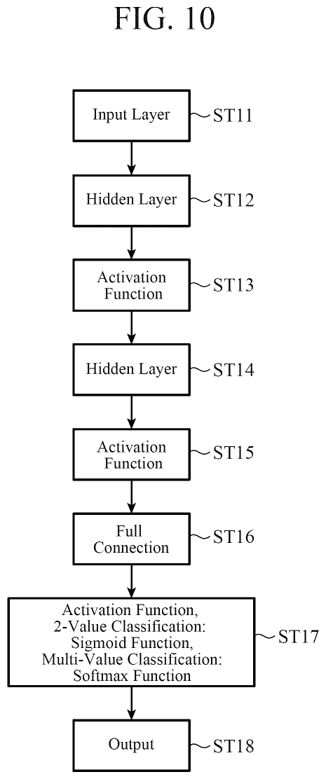

Next, a method for inputting training data to the information processing device 100 and obtaining an output classified into a desired classification number by deep learning or a gradient boosting method will be described. FIG. 10 is a flowchart illustrating an example of a neural network in deep learning of multi-value classification and 2-value classification. In a neural network according to the first embodiment, first, input data is input to an input layer (step ST11), processing is repeated a plurality of times in such a manner that extraction of a feature value in a hidden layer (step ST12), processing by an activation function (step ST13), extraction of a feature value in the hidden layer (step ST14), and processing by the activation function (step ST15) are performed, then full connection is performed (step ST16), processing by the activation function is performed again (step ST17), and a result is output (step ST18).

In deep learning, various methods are known depending on the type of input data, but the information processing device 100 that performs deep learning and another training device that performs general training other than deep learning are similar to each other in that a feature value is extracted in each hidden layer, and a target N-value classification is output by performing full connection immediately before an output or in a hidden layer therebefore. In addition, the information processing device 100 that performs deep learning and another training device that performs general training are similar to each other also in that a loss function, an optimization function, and an error back propagation are used.

Note that a training device that performs general training is different from the first training unit 11 in that the training device that performs general training defines a trained model in such a manner as to output a label for which a value (probability) obtained by performing processing using a softmax function on input data is a maximum value as an inference result (classification result), whereas the first training unit 11 defines a neural network in such a manner that a classification result by inference can be output for all labels. In this way, the information processing device 100 learns the dataset of N-value classification, that is, updates a variable, a weight matrix, a parameter, and the like, and stores the updated training result in the storage unit 20 of the information processing device 100.

### <Data Used for Second Training Unit>

Use of the second training data is a major feature of the information processing device 100 of the first embodiment. The information processing device 100 generates, by the training data generating unit 14, the second training data by using a part of the input data as the first training data and changing a correct answer label of the first training data. The first dataset has N types of correct answer labels as described above. Hereinafter, a case where N is 10 will be described as an example, but N may be another integer as long as N is 3 or more. For example, when generating the second training data, the information processing device 100 first selects one correct answer label (second correct answer label) among the 10 types of correct answer labels.

Next, the information processing device 100 converts input data having a correct answer label other than the selected correct answer label into data with one label (third correct answer label). For example, when generating the second training data, the information processing device 100 first selects 1 among 10 types of integers from 0 to 9 as a correct answer label, then groups training data corresponding to 0 and 2 to 9 other than 1, and allocates one correct answer label to data corresponding to 0 and 2 to 9. For example, the information processing device 100 newly allocates a correct answer label of 0 to the input data of 1, and newly allocates a correct answer label of 1 to the data corresponding to 0 and 2 to 9.

Next, details of the second dataset generated by the information processing device 100 will be described. FIG. 11 is a diagram illustrating an example of the second dataset generated by the information processing device 100. The second dataset (second training data) is a dataset used for training by the second training unit 12, and is, for example, data classified into two types having correct answer labels of 0 and 1 generated as described above.

The second dataset is data classified into two values of correct answer labels, and when the number of pieces of input data classified into 0 is represented by M0, the number of pieces of data classified into 1 is represented by M1, and the like, the number of pieces of data classified into i₀ is Mᵢ₀ in the entire second dataset, and the number of pieces of data classified into a category other than i₀ is represented by equation (1). The second dataset generated in this manner is data of 2-value classification biased in number by a correct answer label. The information processing device 100 performs the above processing from i₀=0 to i₀=9, and generates the second dataset that is a dataset of 2-value classification.

$${\sum }_{i \neq {i}_{0} , i = 0}^{N} {M}_{i} \qquad ( 1 )$$

Note that, in the first embodiment, the case where the second dataset is a dataset of 2-value classification has been described. However, when the first dataset is a dataset of N-value classification, the second dataset only needs to be a dataset of M-value classification satisfying M≤N−1. Note that, in a case where M is 3 or more, the number of combinations of data is larger than that in a case where M is 2, and a calculation amount when the information processing device 100 performs training and inference increases. Therefore, it is desirable to set M to 2 in a case where there is no special reason. In addition, the second training unit 12 may use a combination of M-value classification and multi-value classification other than M-value classification.

### <Learning by Second Training Unit>

Next, a training method of the second training unit 12 using the above-described second training data will be described. As described above, the second training unit 12 performs training of M (≤N−1)-value classification. Hereinafter, for the sake of simplicity, a case where the second training unit 12 performs training of 2-value classification will be described as an example. For example, a loss function (hinge loss) of 2-value classification is expressed by equation (2). The loss function is a function that outputs 0 when 1−t×y is less than 0, and outputs 1−t×y when 1−t×y is 0 or more. Note that t represents an output result of the second training unit 12, and y represents a correct answer label.

$$l ( y ) = max ( 0 , 1 - t \times y ) \qquad ( 2 )$$

In 2-value classification performed by the second training unit 12, a sigmoid function, a log sigmoid function, or the like may be used as a nonlinear activation function immediately before an output layer. Note that, in a case where the second training unit 12 performs M-value classification satisfying 3≤M, the second training unit 12 desirably uses a softmax function similarly to the first training unit 11. Also in 2-value classification, cross entropy (information entropy) can be used as a loss function. In a case where the cross entropy is used, two values are output from the information processing device of 2-value classification, and a result is output by applying the softmax function and the cross entropy to the two values. The sum of the two values before being input to the cross entropy is 1 due to an effect of the softmax function. That is, a value such as [0.63, 0.37] is obtained. On the other hand, in a case where the hinge function or the sigmoid function is used, one value is output from the information processing device of 2-value classification. A result is one value of 0 to 1 due to an effect of the hinge function, and an inference value is changed depending on whether the result is close to 0 or close to 1. Note that, as for a result when only the loss function was changed by the same neural network (VGG13) using CIFAR10, an average of 2-value classification of a test dataset using the hinge function was 98.375%, whereas an average using the cross entropy was 98.694%, which are not much different from each other. In addition, the second training unit 12 may perform deep learning or may perform training using an algorithm other than deep learning.

In addition, the information processing device 100 is not limited to one in which both the first training unit 11 and the second training unit 12 perform deep learning. In a case where both the first training unit 11 and the second training unit 12 perform deep learning, the neural network used by the second training unit 12 may be a smaller neural network of deep learning than that used by the first training unit 11. Here, the small neural network is a neural network having a relatively small number of hidden layers and adjustable parameters. For example, it can be said that MobileNet (the number of parameters is about 3 million) is a smaller neural network than ResNet18 (the number of parameters is about 12 million).

For example, the information processing device 100 is configured in such a manner that the first training unit 11 performs deep learning using ResNet50 that is a neural network, and the second training unit 12 performs deep learning using ResNet18 as a neural network, with respect to an input of CIFAR10. As a result, the information processing device 100 can shorten calculation time required for training and can reduce the size of a trained model stored in hardware. As described above, the information processing device 100 uses the feature that 2-value classification is more likely to obtain high inference accuracy than 10-value classification even in a small network.

Note that the second training unit 12 may be constituted by a plurality of training devices of 2-value classification. In such a case, the second training unit 12 does not need to use the same machine learning algorithm in different training devices of 2-value classification, and may use different machine learning algorithms in a case where inference accuracy is low. For example, the example in which the second training unit 12 performs training using ResNet18 has been described above. However, in a case where sufficient inference accuracy cannot be obtained, the second training unit 12 may switch the algorithm to be used to ResNet32, or in a case where both of ResNet32 and ResNet18 have inference accuracy of 100%, the algorithm to be used may be switched to ResNet18 that is a smaller network. Note that, even in a case where a plurality of training devices in the second training unit 12 uses different networks, the second training unit 12 desirably performs evaluation with the same index between different networks, such as performing output using the same softmax function immediately before an output layer or performing output using the same loss function.

In addition, in a case where outputs of different training devices cannot be evaluated with the same index, the second training unit 12 may define an evaluation index or a correction coefficient depending on a used function, such as using a difference or variation between a first inference value and a second inference value in 2-value classification or performing calibration with a maximum value and a minimum value. In this manner, the second training unit 12 learns the 2-value classification problem and stores a training result in the storage unit 20 such as a ROM, a RAM, a hard disk, or an external storage medium of the information processing device. In addition, since the second training unit 12 is lighter than the first training unit 11 and performs a plurality of calculations similar to each other, it is not necessarily necessary to perform training with a large computer as in conventional machine learning, and training may be performed in a distributed manner with a plurality of small computers.

### <Inference by First Training Unit>

For example, when performing inference, the first training unit 11 calculates a variable, a weight matrix, and a parameter acquired by training in a forward direction with respect to a matrix that is input data. A result of the calculation performed by the first training unit 11 is an output of a softmax function used for training by the first training unit 11, and the output of the softmax function means a probability for each classification of N-value classification, that is, a probability. The information processing device 100 according to the first embodiment defines a candidate having a maximum probability among N candidates as a classification result (inference result) of the first training unit 11.

Note that the information processing device 100 only needs to be able to calculate a probability for each classification of N-value classification, and may perform training using an algorithm other than deep learning. In the following description, among inference candidates, a candidate having the highest probability is defined as a first inference candidate, and a candidate having the second highest probability is defined as a second inference candidate. At this time, the information processing device 100 outputs a classification result using the second training unit 12 in a case where the value (probability) of the first inference candidate is smaller than a threshold (first threshold) separately defined or in a case where the value of the second inference candidate is larger than a threshold (second threshold), which is a feature of the information processing device 100. Note that the first threshold and the second threshold may be the same value, or may be values different from each other, satisfying the second threshold<the first threshold.

In both a case where the probability of the first inference candidate is smaller than the threshold and a case where the second inference candidate is larger than the threshold, when the first inference candidate by the first training unit 11 is defined as a classification result of the information processing device 100, a result different from a classification result obtained by a user is likely to be obtained. As described above, the information processing device 100 sets in advance a threshold for determining a probability of inference, and in a case where it is determined that the probability of inference by the first training unit 11 is low, the second training unit 12 performs inference, whereby inference accuracy can be improved.

### <Inference by Second Training Unit>

In a case where the probability of the first inference result is lower than the threshold, the information processing device 100 performs inference by the second training unit 12. For example, in a case where data input to the information processing device 100 is image data, in the following description, input data in which a probability of the first inference result is lower than the threshold is referred to as first input image data.

The second training unit 12 performs processing on the first input image data. First, when the first input image data is input to the information processing device 100, the second training unit 12 calls trained models in order. For example, all trained models that have performed training are called by a combination of 2-value classification of 0 and (1 to 9), 2-value classification of 1 and (0 and 2 to 9), and 2-value classification of 2 and (0 to 1 and 3 to 9). The information processing device 100 performs, by the second training unit 12, inference on the first input image data using all the trained models, outputs a result of the inference in a case where a probability is classified into a correct answer label in each trained model, that is, 0 in a case of 2-value classification of 0 and (1 to 9), and stores the content of the output in the storage unit 20.

The information processing device 100 performs inference by the second training unit 12. In a case where there are two or more results of inference classified into the correct answer label, the information processing device 100 outputs a result of inference having the highest probability, that is, in a case where a softmax function is used, the information processing device 100 outputs a result of inference having the maximum calculated value as a result of inference by the second training unit 12, and stores the result in the storage unit 20. In addition, the information processing device 100 performs inference by the second training unit 12. In a case where there is no result of inference classified into the correct answer label, the information processing device 100 outputs a label corresponding to the first inference result in the first training unit 11. Note that this processing is processing of calling a 2-value classification model one by one for the first input image, and therefore takes a processing time. For this reason, the information processing device 100 may process input data for which inference needs to be performed by the second training unit 12 with a probability equal to or less than the threshold for each subset or batch of results by using a parallel calculation device such as a GPU.

### <Threshold of First Training Unit>

Next, the above-described threshold will be described. The above-described threshold is set depending on, for example, a dataset, an algorithm used in the first training unit 11, a loss function, and the like by calculating values of the first inference candidate and the second inference candidate for a plurality of inference results and statistically processing the results. For example, the threshold can obtain simple and high inference accuracy by using an average value of the first inference candidates.

Specifically, after the first training unit 11 performs training with training data, the information processing device 100 stores, by the storage unit 20, a probability of the first inference candidate when performing inference by the first training unit 11. In addition, the information processing device 100 calculates, by the probability determining unit 16, an average value of probabilities of the past first inference candidates on the basis of the probabilities of the past first inference candidates stored in the storage unit 20, and stores, by the storage unit 20, the calculation result as a threshold. Note that the information processing device 100 may update the threshold stored in the storage unit 20 as a new threshold every time the information processing device 100 performs inference by the first training unit 11, or may calculate the threshold as a result of the inference by the first training unit 11 using a plurality of pieces of verification data or a plurality of pieces of test data.

In addition, for example, the information processing device 100 first performs, by the first training unit 11, inference on a plurality of pieces of input data, and outputs an inference result (classification result). A user determines whether or not each of the plurality of first inference candidates coincides with the correct answer label on the basis of the inference result output by the information processing device 100, and inputs each determination result to the information processing device 100. The information processing device 100 calculates, by the probability determining unit 16, an average value of probabilities in a case where the first inference candidate coincides with the correct answer label on the basis of the determination result input by the user, and stores, by the storage unit 20, the calculation result as a threshold. In this manner, the information processing device 100 can obtain simple and high inference accuracy by using an average value of probabilities of the first inference candidates.

Note that, as the threshold, for example, a median value, a percentile such as a 25 percentile or a 75 percentile, or a statistical value obtained by performing calculation such as exponent or logarithm on the median value or the percentile may be used. It is possible to further improve the inference accuracy by using these values other than an average value as the threshold depending on bias of data of the dataset or the like. In addition, for example, the threshold is set to be between a statistical value including an average value of probabilities of the first inference candidates in a case where a result of inference by the first training unit 11 is equal to the correct answer label and a statistical value including an average value of probabilities of the first inference candidates in a case where the result of inference by the first training unit 11 is different from the correct answer label.

Specifically, first, the information processing device 100 performs, by the first training unit 11, inference on a plurality of pieces of input data, and outputs an inference result (classification result). A user determines whether or not each of the plurality of first inference candidates coincides with the correct answer label on the basis of the inference result output by the information processing device 100, and inputs each determination result to the information processing device 100. The information processing device 100 calculates, by the probability determining unit 16, an average value of probabilities in a case where the first inference candidate coincides with the correct answer label and an average value of probabilities in a case where the first inference candidate does not coincide with the correct answer label on the basis of a determination result input by a user, sets, by the probability determining unit 16, a predetermined value between the average value of probabilities in a case where the first inference candidate coincides with the correct answer label and the average value of probabilities in a case where the first inference candidate does not coincide with the correct answer label, and stores, by the storage unit 20, the value as a threshold.

More specifically, the information processing device 100 calculates, by the probability determining unit 16, a median value (average value) of the average value of probabilities in a case where the first inference candidate coincides with the correct answer label and the average value of probabilities in a case where the first inference candidate does not coincide with the correct answer label, and stores, by the storage unit 20, the calculation result as a threshold.

In addition, for example, the information processing device 100 first performs, by the first training unit 11, inference on a plurality of pieces of verification data, determines, by the probability determining unit 16, whether or not each of the plurality of first inference candidates coincides with the correct answer label on the basis of the inference result, calculates, by the probability determining unit 16, an average value of probabilities in a case where the first inference candidate coincides with the correct answer label and an average value of probabilities in a case where the first inference candidate does not coincide with the correct answer label, sets, by the probability determining unit 16, a predetermined value between the average value of probabilities in a case where the first inference candidate coincides with the correct answer label and the average value of probabilities in a case where the first inference candidate does not coincide with the correct answer label, and stores, by the storage unit 20, the value as a threshold.

More specifically, the information processing device 100 calculates, by the probability determining unit 16, a median value (average value) of the average value of probabilities in a case where the first inference candidate coincides with the correct answer label and the average value of probabilities in a case where the first inference candidate does not coincide with the correct answer label, and stores, by the storage unit 20, the calculation result as a threshold.

In addition, for example, the threshold may be set in such a manner that inference accuracy is maximized by parameter sweep that continuously changes the threshold. In addition, for example, the threshold may be calculated using a parallel calculation device such as a GPU. In a case where there is spatial or temporal bias in the input data, a difference between the statistically set threshold and the threshold set by parameter sweep is likely to occur, and by calculating an optimum value of the threshold by parameter sweep for the dataset, inference accuracy can be improved.

In addition, a method for changing the threshold depending on an inference candidate is also effective. In the above example, a constant threshold is set regardless of a value of the first inference candidate, whereas in a case of 10-value classification, the threshold is calculated for each of the first inference candidates which are 0, 1, 2, 3, 4, 5, 6, 7, 8, and 9 on the basis of statistical information. Note that, in a case where the amount of data classified as errors is small due to high inference accuracy, a small amount of inference data, or the like, specifically, in a case where the number of pieces of data is less than 100, a value as statistical information is small. Therefore, a method for changing the threshold depending on an inference candidate is not desirable, and in this case, it is desirable to use a constant threshold regardless of a value of the first inference candidate.

In addition, the same applies to a case where the second inference candidate is used as a threshold, and a statistical method such as an average value or a median value may be used. A determination method by parameter sweep is also an effective means also in the second inference candidate if an inference time and calculation resources given to inference allow it. Furthermore, in an environment where a parallel calculation device such as a GPU cannot be used, in order to reduce calculation time, it is not necessary for the second training unit 12 to perform inference on all pieces of the first input data that are equal to or less than a threshold, and it is also desirable to use the second training unit 12 only in a case where the first training unit 11 classifies in advance the data into a correct answer label that is likely to be mistaken.

### Experimental Results

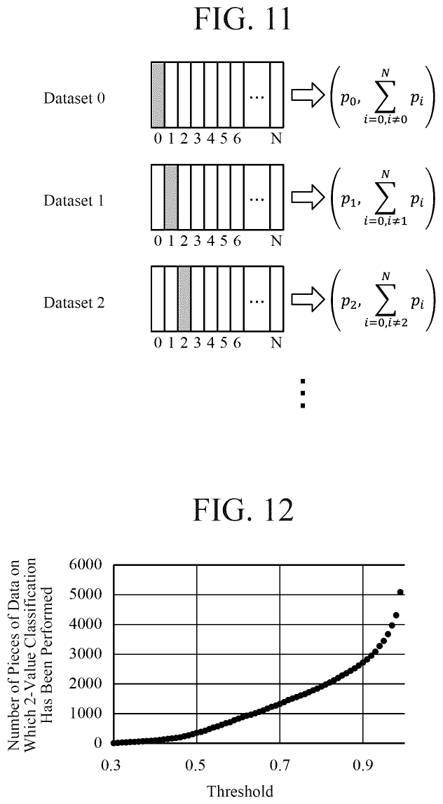

Next, experimental results of classification performed by the information processing device 100 will be described with reference to FIGS. 12 to 14. FIG. 12 is a diagram illustrating the number of pieces of data for which 2-value classification has been calculated for a threshold by the information processing device 100 among 10,000 pieces of test data of CIFAR10. In this experiment, CIFAR10 was used as a dataset input to the information processing device 100. CIFAR10 is a dataset including 50,000 pieces of training image data and 10,000 pieces of test image data and classified into 10 values of an airplane, a car, a bird, a cat, a deer, a dog, a frog, a horse, a ship, and a truck. In this experiment, 50,000 pieces of training data were input to the information processing device 100 without creating verification data, and training by the first training unit 11 was performed by ResNet50 that is one method of CNN.

ResNet50 includes 48 convolution layers, one maximum value pooling layer, and one average value pooling layer. Poisson negative log likelihood loss was used as a loss function, but any loss function such as cross entropy, least square error (MSE), mean absolute error (MAE), or a defined unique error function may be used. In addition, Adam having a learning ratio of 0.01 was used as an optimization function, but any optimization function such as momentum, RMSprop, stochastic gradient descent (SGD), or a defined unique error function may be used. In addition, a Step LR function was used as a scheduler that varies a learning ratio, but many schedulers such as a Cosine Annealing LR function and a Cyclic LR function are known, and any scheduler may be used as long as inference accuracy for test data can be secured, similarly to the loss function and the optimization function. An initial value of Xavier was used as a weight matrix of convolution, that is, an initial value of a filter.

When training was performed with a training batch size of 64, a test batch size of 1,000, and epoch times of 20, it was confirmed that inference accuracy of the first training unit 11 was 86.28% for the test dataset. In a case of this definition, since the inference value takes a real number between 0 and 1, a result of calculating the number of the first inference candidates taking a number between 0.30 and 0.99 is illustrated in FIG. 12. For example, 0.9 means that 2617 pieces of test data are inferred by 2-value classification among 10,000 pieces of test data.

Next, 2-value classification will be described. As a dataset of 2-value classification, 10 datasets were created from the first dataset in such a manner that a set of an airplane and others, a set of a car and others, a set of a bird and others, a set of a cat and others, a set of a deer and others, a set of a dog and others, a set of a frog and others, a set of a horse and others, a set of a ship and others, and a set of a truck and others were created. For example, in a case of the set of an airplane and others, a correct answer label of the airplane was defined as 0, and a correct answer label of the others was defined as 1. In this way, the dataset of the airplane includes 5,000 pieces of data, and the dataset of the others includes 45,000 pieces of data.

The second training unit 12 used ResNet18 that is one method of CNN. A hinge loss was used as a loss function, but any loss function such as a defined unique error function may be used. In addition, Adam having a learning ratio of 0.01 was used as an optimization function, but any optimization function such as a defined unique error function may be used. In addition, a Cosine Annealing Warm Restarts function was used as a scheduler that varies a learning ratio, but any scheduler may be used as long as inference accuracy for test data can be secured, similarly to the loss function and the optimization function. An initial value of Xavier was used as a weight matrix of convolution, that is, an initial value of a filter as in the first training unit 11. When training was performed with a training batch size of 250, a test batch size of 1,000, and epoch times of 10, an inference result of airplane: 97.01%, car: 98.90%, bird: 96.02%, cat: 94.85%, deer: 96.96%, dog: 96.31%, frog: 98.36%, horse: 98.35%, ship: 98.71%, and truck: 98.30% was obtained by 2-value classification for the test dataset.

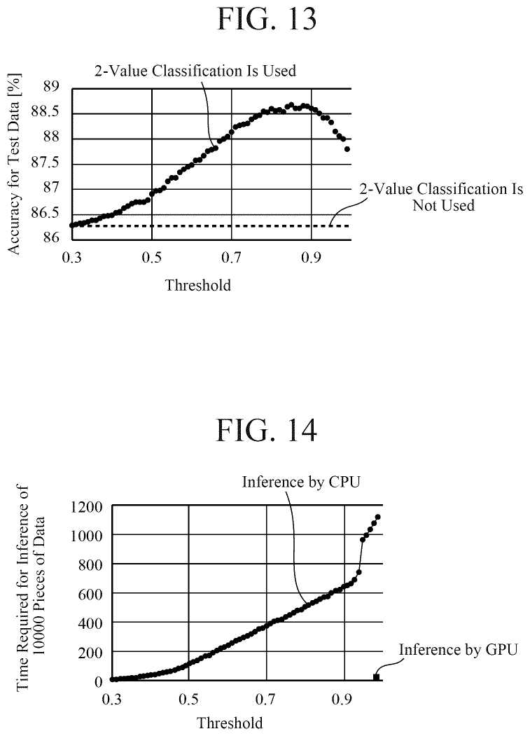

Next, an inference result using the first training unit 11 and the second training unit 12 will be described. FIG. 13 is a diagram illustrating experimental data of an inference result in a case where the information processing device uses 2-value classification for CIFAR10 and a case where the information processing device does not use 2-value classification for CIFAR10. An inference method is the same as the method described with reference to FIG. 5. At this time, a result of performing an experiment under a condition that the second training unit 12 is not notified of an inference candidate of the first training unit 11 is described. A reference for comparison is 86.28%, which is inference accuracy in a case where only the first training unit 11 is used. FIG. 13 illustrates an inference result using the first training unit 11 and the second training unit 12 when a threshold for the first inference candidate is moved from 0.3 to 0.99. As illustrated in the figure, it is found that the inference accuracy is improved as the threshold increases and the number of pieces of data to be subjected to 2-value classification increases, and a maximum value of 88.70% is obtained when the threshold is 0.85.

On the other hand, it is found that the inference accuracy decreases when the threshold exceeds 0.86. This result means that the inference accuracy is improved by 2% or more as compared with 86.28% that is the inference accuracy serving as a reference, and an effect of using a combination of multi-value classification and 2-value classification is indicated. It should be further noted that a result exceeding the result of inference only by the first training unit 11 is obtained with all the thresholds of 0.3 to 0.99 by using the second training unit 12, and the inference accuracy can be improved by using the second inference candidate regardless of the threshold at least under the above conditions.

FIG. 14 illustrates an inference time with respect to a threshold. FIG. 14 is a diagram illustrating experimental data of time required for the information processing device 100 to perform inference on 10,000 pieces of data for a threshold of CIFAR10. The inference was not parallelized using a GPU or the like, and was sequentially calculated by a CPU. As can be seen from this result, in a case where 2-value classification is not used, the inference ends in 6 seconds, but inference calculation time of 570 seconds, which is about 100 times, is required at a threshold of 0.86. Since most of this calculation time is a time required for calling a trained model from a ROM, when parallelization cannot be performed, it is desirable to call a trained 2-value classification model in a RAM. In addition, FIG. 14 also illustrates a result of storing data that is equal to or less than a threshold and processing the data with a GPU. It is found that, at a threshold of 0.99 at which it takes the longest time, it takes 1119 seconds in the CPU, whereas in the GPU, it takes 16.6 seconds, which is decreased by 98.5%. In addition, there is no significant difference between this result and a result of 3 seconds when no threshold was used.

Currently, many pieces of artificial intelligence-dedicated hardware have a large memory, and it is not difficult to place a trained model on a memory of a GPU. In particular, the size of the present trained model is 103 MB for 10-value classification and 47 MB×10 for 2-value classification, and is sufficiently small even when a memory of a recent GPU is considered. In addition, in order to solve an N-value classification problem, N parallel ASICs may be prepared, and calculation units may perform inference of 2-value classification in parallel. In addition, in ResNet50 and ResNet18, the file size, that is, the number of parameters of a weight matrix is large even with the same inference accuracy, for example, as compared with EfficientNet or MobileNet, and therefore, in a case where the file size is a problem, the problem can be solved only by changing a model.

As described above, the information processing device 100 according to the first embodiment selects to output a classification result by the first classification unit 11C in a case where a probability of inference by the first classification unit 11C exceeds a preset threshold, and outputs a classification result by the second classification unit 12C that classifies data into a smaller number of classes than the first classification unit 11C in a case where the probability of inference by the first classification unit 11C is equal to or less than the threshold. Therefore, it is possible to improve inference accuracy of input data regardless of the amount of input data when a trained model is generated.

In addition, since it is possible to obtain high inference accuracy without using a large-scale machine learning device, it is possible to reduce a calculation amount required to obtain the same inference accuracy as in related art. Therefore, it is possible to reduce calculation resources, shorten training time, and reduce cost. In addition, since it is possible to reduce the amount of data required to obtain the same inference accuracy as in related art, it is possible not only to train a machine learning device with a simple device configuration at low cost but also to lower a hurdle for utilizing machine learning. In particular, a significant difference occurs in a neural network requiring a large amount of data. Furthermore, one conventional large-scale machine learning device of N-value classification needs to perform training by one large-scale computer. However, the training device of N-value classification can be downsized, and instead, a plurality of devices of M-value classification can perform training by different small-sized computers, for example, computers not equipped with dedicated hardware such as a GPU in a dispersed manner. Therefore, utilization of the machine learning device is facilitated.

### Second Embodiment

### <Inference by Second Training Unit>

A second embodiment is characterized in that, in a case where a probability is equal to or less than a threshold as a result of inference by a first training unit 11, the first training unit 11 provides a first inference candidate having the highest probability, obtained by the inference by the first training unit 11 to a second training unit 12. The second training unit 12 is a device trained with a dataset constituted by a combination of every two values described in the first embodiment, and performs determination by first using the first inference candidate and a trained model trained with the other data. As a result of the determination, in a case where a result different from the first inference candidate is obtained, inference is performed in all combinations of the second training unit 12, and an inference result having the highest probability is defined as an inference result of the second training unit 12.

Taking CIFAR10 described in the first embodiment as an example, in a case where the first inference candidate is an airplane, for example, the second training unit 12 performs inference by 2-value classification trained with the dataset of the airplane and others. In a case where the inference result is the airplane, that is, in a case where a probability (first probability) of a class of the first inference candidate calculated by the second probability calculating unit 12B is higher than a probability (second probability) of the other classes, the second training unit 12 outputs the airplane, that is, the class of the first inference candidate. In a case where the inference result is the others, inference is performed for all the combinations, resulting in 2-vale classification by the second training unit 12, of the airplane and others, a car and others, a bird and others, a cat and others, a deer and others, a dog and others, a frog and others, a horse and others, a ship and others, and a truck and others, inference candidates of results that are not the others are compared, and an inference result is determined on the basis of the comparison result. For example, one having the smallest value or one having the largest value depending on an output function is defined as the inference result.

For example, in a case where values of the airplane and the others are 1.0 and 1.5, respectively, and values of the ship and the others are 0.8 and 2.6, respectively, comparison is performed between 1.0 and 0.8, which are smaller values, and 0.8 is smaller. Therefore, the ship is defined as the inference result. In addition to the minimum value, a result with a larger difference, that is, in the above example, (1.5−1.0=0.5) and (2.6−0.8=1.8) may be compared, the differences 0.5 and 1.8 may be compared, and the ship with a larger difference may be defined as the inference result. Although description has been given for 2-value classification, the same applies to 3 or more-value classification, and in the case of 3 or more-value classification, a difference between top two inference results only needs to be used. Note that, as a result of the above calculation, in a case where all the inference results of 2-value classification are classified into the others, the first inference candidate is output as the inference result of the second training unit 12. By using this method, it is possible to reduce time required for inference without reducing the inference accuracy.

### Third Embodiment

### <Data Used for Second Training Unit>

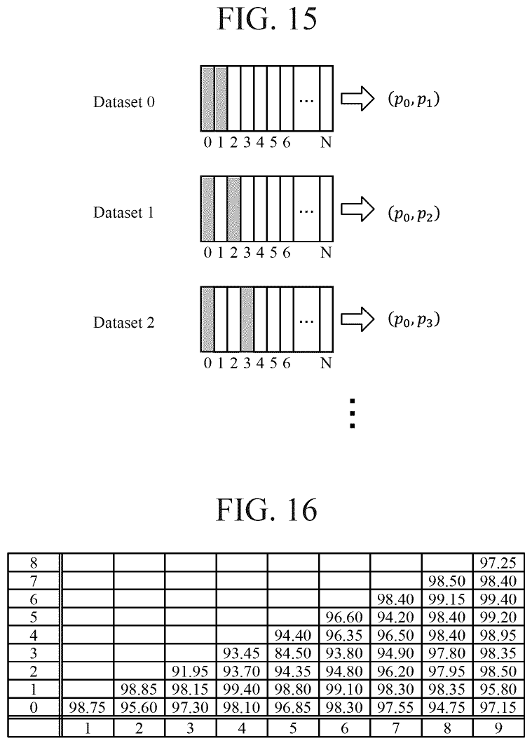

In a third embodiment, a dataset used for a second training unit 12 will be described. In the first and second embodiments, in a case where the dataset used for the second training unit 12 is subjected to N-value classification, the number of the datasets is N. Meanwhile, in a case where the dataset in the present embodiment is subjected to N-value classification, when a natural number of N or less is represented by L (third number), any L (third number) correct answer labels (first correct answer labels) are selected, and a second dataset is constructed with input data having the L correct answer labels. FIG. 15 illustrates a configuration example of some datasets. As illustrated in FIG. 15, L correct answer labels are selected from N-value classification at a time, and a dataset for L-value classification is created. Therefore, the following A datasets are created. Hereinafter, for the sake of clarity, a case where N is 10 and L is 2 will be described, but other integers may be used.
A1=(N, L)

In a case where N is 10 and L is 2, these 10 values are classified into a combinations of every two values. For the sake of simplicity, in a case of 3-value classification from 0 to 2, different correct answer labels such as 0 and 1, 0 and 2, and 1 and 2 are combined to form a second dataset. When the combination is performed in this manner, A is A1 described below, that is, 45 datasets are created. The datasets thus classified into two values are input to the second training unit 12, and training is performed. The second training unit 12 is similar to that of the first embodiment.
A1=(10, 2)

The number of the second training units 12 that perform training needs to be 45, which is the same as the number of the datasets, and inference accuracy for a test dataset that is not used for training data may be deteriorated. In this case, change to an algorithm with high accuracy may be performed. In addition, there is a case where accuracy for the test dataset is 100%, and in this case, similarly to the first embodiment, a calculation time and a calculation amount can be reduced by change to a simpler algorithm. Therefore, in addition to being different from the first training unit 11, the second training unit 12 may use calculation of an algorithm that varies depending on a dataset in the second training unit 12, but as described in the first embodiment, it is desirable to use the same loss function and activation function immediately before an output layer.

FIG. 16 illustrates a result of training 2-value classification by a method based on the present embodiment in CIFAR10 and performing inference on each 2-value classification with a test dataset. The number 0 indicates an airplane, the number 1 indicates a car, the number 2 indicates a bird, the number 3 indicates a cat, the number 4 indicates a deer, the number 5 indicates a dog, the number 6 indicates a frog, the number 7 indicates a horse, the number 8 indicates a ship, and the number 9 indicates a truck. Although the results of inference accuracy are approximately 90% or more, it is found that the accuracy of the classification of the cat for the number 3 and the dog for the number 5 is as low as 84.5%. In such a problem, it is desirable to increase inference accuracy by using a larger network or using data augmentation in a case of an image.

In this manner, parameters which the trained second training unit 12 has learned are stored, and inference is performed by the second training unit 12 in a case where a probability of an output result of the first training unit 11 is equal to or less than a threshold. Note that, in order to achieve reduction in calculation amount, similarly to the first embodiment, it is not necessary to use the second training unit 12 for all pieces of data that are equal to or less than the threshold, and a calculation time may be reduced using 2-value classification only in a case where the first inference result is a combination that is likely to be mistaken or a classification value that is likely to be mistaken for the first inference result. For example, in the dataset of CIFAR10, since there is a combination that is likely to be mistaken, such as a cat and a dog or a ship and an airplane, the second training unit 12 may be used only in a case where a cat, a dog, a ship, and an airplane are the first inference candidates. It is desirable to perform inference once and quantify and evaluate a combination of erroneous pieces of data for this error easiness.

Although the case where the second training unit 12 performs 2-value classification has been described above, 3 or more-value classification may be used. This is because the inference accuracy is improved as the classification number decreases. Note that, when the classification number is 2 or more, such as 3-value classification, the number of combinations increases, and when 10-value classification is divided into 3-value classification, 120 second training units 12 are required. Therefore, as described above, it is necessary to reduce a calculation amount required for inference by use only in a case where inference is performed on a label that is likely to be mistaken by the first training unit 11.

### Fourth Embodiment

### <Inference by Second Training Unit>

A fourth embodiment is characterized in that, in a case where an inference result of a first training unit 11 is equal to or less than a threshold, the first training unit 11 provides a first inference candidate and a second inference candidate having the top two probabilities, obtained by the inference by the first training unit 11 to a second training unit 12. At this time, the second training unit 12 performs inference using the N trained models of 2-value classification described in the first embodiment or the A1 trained models of 2-value classification described in the second embodiment.

In a case where the N trained models of 2-value classification are used, for example, when the first inference candidate is 5 and the second inference candidate is 6, inference is performed with a trained model trained by a second dataset including 5 and the other results. When 5 is an inference result, 5 is output. When an inference result other than 5 is obtained, inference is performed with a trained model trained by a second dataset including 6 and the other results. When a probability (third probability) classified into 6 is higher than a probability (fourth probability) classified into results other than 6, 6 is output. Furthermore, in a case where the N 2-value classifications are used, when there are sufficient calculation resources, inference is performed with both the trained models of 5 and 6, the magnitudes of the probabilities of the two results of inference are compared, and a more probable result, for example, 5 is output.

In a case where the A1 trained models of 2-value classification are used, for example, when the first inference candidate is 5 and the second inference candidate is 6, inference is performed with a trained model trained with a second dataset including 5 and 6. When the inference is performed, either 5 or 6 is a result having a high probability, and therefore, for example, 5 is output as the inference result. In the present embodiment, it has been described that the top two inference candidates of the first training unit 11 are output, but the top P inference candidates may be provided to the second training unit 12. Similarly to the above, in a case where the N trained models of 2-value classification are used, a more probable inference result is output among the top P inference results.

In particular, in a case where the N 2-value classifications are used, if inference values rearranged with a probability in order of the inference candidates of the first training unit 11, that is, a third inference candidate and a fourth inference candidate can be obtained, inference is performed in order such as the third inference candidate in a case where the second inference candidate is the others and the fourth inference candidate in a case where the third inference candidate is the others, and in a case where the others are not obtained, the inference value can be provided to the second training unit 12 as the inference result. Note that, in a case where all the second inference results are the others, the first inference candidate is output as the inference value.

### Fifth Embodiment

### <Threshold of First Training Unit>

In a fifth embodiment, how to determine a threshold will be described. In inference by the first training unit 11, the threshold is characterized by being obtained by statistically processing a result of an output of N values. For example, assuming that the number of test datasets on which inference is performed is 10,000, and the number of datasets for which a correct answer is obtained in the inference by the first training unit 11 is 9,000 among the 10,000 datasets, a matrix of 9,000×N is obtained when only the datasets having the correct answer are collected, and this is called a correct answer matrix. In addition, when only datasets having an incorrect answer are collected, a matrix of 1,000×N is obtained, and this is called an error matrix. Then, for example, by rearranging each matrix in such a manner that the smaller the column is, the higher the probability is, a 9,000×N correct answer matrix and a 1,000×N error matrix in which a first column has a maximum value and an N-th column has a minimum value are obtained.

That is, a matrix is created by arranging an output of a softmax function in order of magnitude for each dataset. For simplicity, description will be given this time assuming that the first column is the first inference candidate. Depending on the definition of a loss function, the first inference candidate having a minimum value may be the N-th column, or arrangement may be performed in such a manner that the first column is a minimum value and the N-th column is a maximum value.

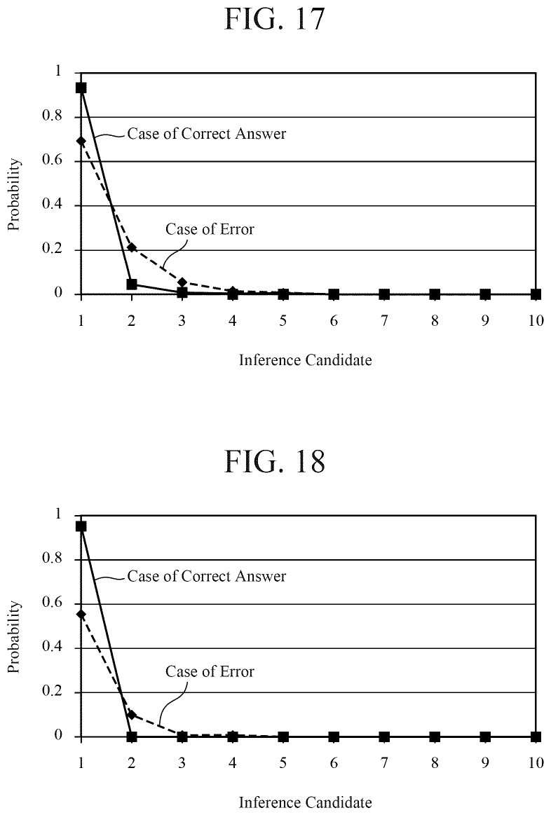

The correct answer matrix and the error matrix are statistically processed. For the statistical processing, an average value and a percentile are considered. In particular, in a case of 50 percentile, a median value is used. First, the average value will be described as an example. When values in the first columns of the correct answer matrix and the error matrix are compared, the value in the first column of the correct answer matrix is larger than the value in the first column of the error matrix. FIG. 17 illustrates an average value of inference results in the first training unit 11 having inference accuracy of 86.28% in CIFAR10 described in the first embodiment. The solid line in the figure indicates an average value of the correct answer matrix, and the broken line indicates an average value of the error matrix.

In this inference value, a value between an average value of the first columns of the correct answer matrices and an average value of the first columns of the error matrices is desirably defined as the threshold. For example, since a value of the first column of the correct answer matrix is 0.93 and a value of the first column of the error matrix is 0.70 in FIG. 17, it is desirable to define the threshold between 0.70 and 0.93. In particular, when the threshold is increased, the number of pieces of data to be subjected to 2-value classification increases, and a calculation amount required for inference increases. However, when the threshold is increased, the inference accuracy can be improved. Therefore, the threshold only needs to be determined depending on calculation resources, a calculation time, and necessary calculation accuracy to be used for the calculation. The threshold in FIG. 17 is the same as the calculation accuracy for the threshold illustrated in FIG. 13, and the maximum value in FIG. 12 corresponds to a threshold of 0.85, and therefore is included in the range of 0.70 to 0.93.

Furthermore, the same applies to a case where a median value, a 25 percentile, or a 75 percentile is used. As an example, FIG. 18 illustrates a result of calculating median values for the above correct answer matrix and the error matrix. Also in the median value, similarly to the above average value, a value between a median value of the first columns of the correct answer matrices and a median value of the first columns of the error matrices is desirably defined as the threshold. That is, it is desirable to define the threshold between 0.56 and 0.96. Also in this case, it is found that the fact that the maximum value in FIG. 13 corresponds to a threshold of 0.85 satisfies this. In the case of the median value, similarly to the case of the average value, the threshold is desirably large. However, the threshold may be determined depending on calculation resources, a calculation time, and necessary calculation accuracy. In addition, since this is a result of training CIFAR 10 by ResNet50, how to determine a threshold desirably follows the above method although a value varies depending on a case where the above result is obtained but data other than an image is extracted, in a case where the above result is obtained but a feature value of an image is extracted by another algorithm, or the definition of the loss function.

Furthermore, these statistical values such as an average value and a median value can be used in combination. For example, in a case where the average value of the first columns of the correct answer matrices is 0.8, the average value of the first columns of the error matrices is 0.6, the median value of the first columns of the correct answer matrices is 0.9, and the median value of the first columns of the error matrices is 0.5, a method for defining a range of the threshold between 0.5 to 0.8 by setting an upper limit of the threshold to 0.8, which is the average value of the first columns of the correct answer matrices, and a lower limit of the threshold to 0.5, which is the median value of the first columns of the error matrices is also desirable usage.

### Sixth Embodiment

### <Threshold of First Training Unit>

In the fifth embodiment, the correct answer matrix and the error matrix have been described. In a sixth embodiment, a method for deriving a threshold from statistical information of the second column having the second largest value for the same correct answer matrix and error matrix will be described. As in the fifth embodiment, calculation is performed on the basis of an average value or a median value of the second columns. For example, as illustrated in FIG. 17 illustrating the result of inference using CIFAR 10 as a dataset in the average, the threshold of the second column is 0.047 for the correct answer matrix and 0.207 for the error matrix. Therefore, the threshold is desirably defined between 0.047 and 0.21. Similarly, in a case where the median value is used as the reference of the threshold, as illustrated in FIG. 18, the threshold of the second column is 0.00025 for the correct answer matrix and 0.0953 for the error matrix. Therefore, the threshold is desirably defined between 0.00025 and 0.0953.

Similarly to FIG. 13, when the inference accuracy of the test dataset for the thresholds of 0.01 to 0.30 in increments of 0.01 is calculated, the inference accuracy is maximum in a case of 0.10, and 88.66% of accuracy is obtained. This result is almost the same inference accuracy as the maximum value of 88.70% illustrated in FIG. 13, and it is found that almost the same inference accuracy can be achieved without using the first inference candidate as the threshold. In addition, the threshold based on the above average value is 0.047 to 0.21, and the inference accuracy is reduced at 0.15 or more in FIG. 13. Therefore it is found that a maximum effect can be obtained by defining the threshold within the range of the average value. In addition, the threshold based on the median value is 0.00025 to 0.0953, which indicates a result close to 0.1 at which the inference accuracy is a maximum value.

Although the case where the first inference candidate is used in the fifth embodiment and the case where the second inference candidate is used in the sixth embodiment have been described, a difference between the first inference candidate and the second inference candidate may be used. That is, when an average value of differences between the first inference candidate and the second inference candidate in the correct answer matrix is referred to as a correct answer average value, and an average value of differences between the first inference candidate and the second inference candidate in the error matrix is referred to as an error average value, the correct answer average value is larger than the error average value all times. Therefore, the threshold can also be defined by defining the threshold to be equal to or more than the error average and equal to or less than the correct answer average.

Furthermore, by combining the average value and the median value of the first inference candidates and the average value and the median value of the second inference candidates, a value between the average value of the first inference candidates and the average value of the second inference candidates and between the median value of the first inference candidates and the median value of the second inference candidates may be defined as the threshold. Here, description has been given by using the average value and the median value, but a value extracted by another statistical method may be defined as the threshold.

### Seventh Embodiment

### <Threshold of First Training Unit>

The correct answer matrix and the error matrix described in the fifth and sixth embodiments are matrices created by the result of inference performed by the first training unit 11 on all the pieces of test data. However, in a case where the test data is large or calculation resources are small, a calculation time and a calculation amount required for inference increase. In addition, in a case where a parallel processable device such as a GPU is used, it is common to input the test data as a batch that is a collective set without putting the test data into the first training unit 11 one by one also in inference. The size of the batch depends on a memory amount of a GPU or the like.

In the seventh embodiment, statistical processing is not performed after inference on all the pieces of test data is completed, but the correct answer matrix and the error matrix are calculated using a part of test data or a matrix in which one batch process is completed. For example, in a case where there are 10,000 pieces of test data, when 1,000 pieces of data, which are a part of the data, are collected, or when 1,000 pieces of data are put together in a parallel processable device in a batch, one batch is calculated, and the correct answer matrix and the error matrix are created from the result.

At this time, it is not necessary to perform inference using N-value classification a plurality of times by leaving data having a probability for each classification value that is inference on a memory (RAM), and inference may be performed on a result that the data on the memory does not reach the threshold by the 2-value classification device described in the first to fourth embodiments.

In the above processing, the correct answer matrix and the error matrix are calculated every time one set or one batch process is completed. This method is effective in a case where there are variations in correct answer labels of the test data and the like, for example, in the example of CIFAR10, when a set or batch of many pictures of an airplane is obtained. Meanwhile, in a case where pieces of the test data are sufficiently randomly arranged, the following method can be used. That is, a threshold derived from a correct answer matrix and an error matrix calculated from one set or one or more batch processes is applied also to the remaining test data. This is established in a case where the above set or one or more batches are a subset close to the entire test data, and this can reduce a calculation amount required for inference and shorten an inference time.

Note that the present disclosure can freely combine the embodiments to each other, modify any constituent element in each of the embodiments, or omit any constituent element in each of the embodiments.

### INDUSTRIAL APPLICABILITY

The information processing device according to the present disclosure can be used for classifying input data.

### REFERENCE SIGNS LIST

11A: first model generating unit, 11B: first probability calculating unit, 11C: first classification unit, 12A: second model generating unit, 12B: second probability calculating unit, 12C: second classification unit, 13A: first feature value extracting unit, 13B: second feature value extracting unit, 14: training data generating unit, 15: threshold setting unit, 17: classification result selecting unit, 100: information processing device

1. An information processing device comprising:
a processor; and
a memory storing a program, upon executed by the processor, performing a process:
to extract a feature value of input data;
to perform inference on the input data on a basis of the feature value extracted, and to calculate a probability with which the input data is classified into each of a first number of classes; and
to classify the input data into at least one of the first number of classes on a basis of the probability calculated, wherein
the process performs
a first process of rearranging the input data in such a manner that the probability calculated is in ascending or descending order,
a second process of extracting a label having a maximum probability from the rearranged input data,
a third process of comparing the label having the maximum probability with a correct answer label associated with the input data,
a first storage process of storing a class obtained in the first process, in which the labels coincide with each other as a comparison result of the third process,
a second storage process of storing a class obtained in the first process, in which the labels do not coincide with each other as a comparison result of the third process,
a first statistical process of statistically processing the class stored by the first storage process,
a second statistical process of statistically processing the class stored by the second storage process, and
to classify the input data on a basis of the comparison result between the probability calculated and the threshold value set on a basis of at least one of the results of the first statistical process and the second statistical process.

2. The information processing device according to claim 1, wherein
the first statistical process and the second statistical process are each processing of calculating any one or a combination of two or more of an average value, a median value, a standard deviation, and information entropy.

3. The information processing device according to claim 1, the process comprising to set a threshold to be equal to or less than a first statistical value calculated by the first statistical process, wherein
the process classifies the input data on a basis of a comparison result between a probability calculated and the threshold.

4. The information processing device according to claim 3, wherein
the process sets a threshold to be equal to or more than a second statistical value calculated by the second statistical process.

5. The information processing device according to claim 4, wherein
the process sets the threshold to be an average value of the first statistical value and the second statistical value.

6. The information processing device according to claim 4, wherein
the process sets the threshold to be a weighted average value using the number of pieces of input data assigned to the first statistical value and the second statistical value as a weight.

7. The information processing device according to claim 3, the process comprising to extract a feature value of the input data, the feature value being different from the feature value extracted, wherein
inference is performed in a case where a value of a label extracted in the second process, to be compared with the threshold, is equal to or less than the threshold.

8. The information processing device according to claim 3, the process comprising to extract a feature value of the input data, the feature value being different from the feature value extracted, wherein
the process performs a process of extracting a value having the second highest or lower probability from the input data rearranged in the first process, and
inference is performed in a case where a value of a label extracted in the process, to be compared with the threshold, is equal to or more than the threshold.

9. The information processing device according to claim 3, the process comprising:
to extract a feature value of the input data, the feature value being different from the feature value extracted;
to perform inference on the input data on a basis of the feature value extracted, and to calculate a probability with which the input data is classified into each of a second number of classes, the second number being equal to or less than the first number;
to classify the input data into any one of the second number of classes on a basis of the probability calculated; and
to select which of the result classified and the result classified is to be output, wherein
the process performs inference on the input data on a basis of the feature value extracted, and to calculate a probability with which the input data is classified into each of the first number of classes,
the process classifies the input data into a class having the highest probability calculated among the first number of classes, and
the process selects to output the result classified in a case where a probability calculated for a class into which the process has classified the input data exceeds a preset threshold, and selects to output the result classified in a case where the probability calculated for the class into which the process has classified the input data is equal to or less than the threshold.

10. The information processing device according to claim 9, wherein
the process classifies the input data into two classes on a basis of a feature value extracted.

11. The information processing device according to claim 10, wherein
the process calculates a first probability with which the input data is classified into a first class having the highest probability calculated among the first number of classes and a second probability with which the input data is classified into a class other than the first class in a case where the probability calculated for the class into which the input data is classified is equal to or less than the threshold, and
the process classifies the input data into the first class in a case where the first probability is higher than the second probability.

12. The information processing device according to claim 9, the process comprising:
to generate a first trained model on a basis of a first dataset including correct answer labels of the first number classification and a plurality of pieces of input data associated with the respective correct answer labels of the first number classification; and
to generate a second trained model on a basis of a second dataset including correct answer labels of the second number classification and a plurality of pieces of input data of the first dataset associated with the respective correct answer labels of the second number classification, wherein
the process performs inference on the input data on a basis of the first trained model, and
the process performs inference on the input data on a basis of the second trained model.

13. The information processing device according to claim 12, wherein
the second trained model has a smaller number of adjustable parameters than the first trained model.

14. The information processing device according to claim 12, wherein
when one correct answer label among the correct answer labels of the first number classification of the first dataset is defined as a second correct answer label, and a correct answer label of training data that does not correspond to the second correct answer label among the correct answer labels of the first number classification of the first dataset is defined as a third correct answer label,
the process classifies the input data into two classes corresponding to the second correct answer label and the third correct answer label.

15. The information processing device according to claim 14, the process comprising to generate, on a basis of the first dataset, the second dataset including the second correct answer label and the third correct answer label, and a plurality of pieces of training data of the first dataset associated with the second correct answer label and the third correct answer label.

16. The information processing device according to claim 15, wherein
when the highest probability among probabilities with which the input data is classified into the respective first number of classes, calculated is defined as a fifth probability,
the process sets the threshold to be a value between one of an average value and a median value of the fifth probability when a result that coincides with a class corresponding to the correct answer label is obtained among results obtained by classifying the plurality of pieces of input data of the first dataset and one of an average value and a median value of the fifth probability when a result that does not coincide with the class corresponding to the correct answer label is obtained among the results obtained by classifying the plurality of pieces of input data of the first dataset.

17. The information processing device according to claim 16, wherein
the process sets the threshold for each subset of input data included in the first dataset.

18. The information processing device according to claim 16, wherein
the process sets the threshold for each of a plurality of classes classified.

19. An information processing method, the method comprising:
extracting a feature value of input data;
performing inference on the input data on a basis of the feature value extracted, and calculating a probability with which the input data is classified into each of a first number of classes;
classifying the input data into a class having the highest probability calculated among the first number of classes;
performing inference on the input data on a basis of the feature value extracted, and calculating a probability with which the input data is classified into each of a second number of classes, the second number being smaller than the first number;
classifying the input data into any one of the second number of classes on a basis of the probability calculated; and
selecting which of the result classified and the result classified is to be output, wherein
the method selects to output the result classified in a case where a probability calculated for a class into which the method has classified the input data exceeds a preset threshold, and selects to output the result classified in a case where the probability calculated for the class into which the method has classified the input data is equal to or less than the threshold.

20. The information processing device according to claim 1, wherein
the second process is processing of extracting a label having a minimum value, and
the third process is processing of comparing the label having a minimum value with a correct answer label associated with the input data.
